(19) United States
(12) Patent Application Publication
(10) Pub. No.: US 2014/0105151 A1
(43) Pub. Date: Apr. 17, 2014

(54) METHOD FOR RESOURCE ALLOCATION AND TRANSMISSION IN WIRELESS COMMUNICATION SYSTEM, AND TRANSMITTING DEVICE THEREOF, RECEIVING DEVICE CORRESPONDING THERETO

(71) Applicant: Sungkwon Hong, Seoul (KR)

(72) Inventor: Sungkwon Hong, Seoul (KR)

(73) Assignee: Pantech Co., Ltd, Seoul (KR)

(21) Appl. No.: 14/118,220

(22) PCT Filed: May 10, 2012
(86) PCT No.: PCT/KR2012/003659

§ 371 Date: Nov. 15, 2013

(30) Foreign Application Priority Data
May 18, 2011 (KR) 10-2011-0047066

(51) Int. Cl. H04W 72/04

(52) U.S. Cl. CPC H04W 72/04
USPC 370/329

(57) ABSTRACT

The present invention relates to a method for resource allocation in a wireless communication system, a device thereof, and a system thereof.

### CROSS-REFERENCE TO RELATED APPLICATIONS

This application is the National Stage Entry of International Application PCT/KR2012/003659, filed on May 10, 2012, and claims priority from and the benefit of Korean Patent Application No. 10-2011-0047066, filed on May 18, 2011, all of which are incorporated herein by reference in their entireties for all purposes as if fully set forth herein.

### BACKGROUND

1. Field

The present invention relates to a resource allocation method in a wireless communication system, a device thereof, and a system thereof.

2. Discussion of the Background

In a wireless communication system, one of the basic principles of wireless connection is shared channel transmission, that is, dynamic sharing of time-frequency resources among user equipments. In this example, a base station controls allocation of uplink and downlink resources.

In particular, the base station provides allocation information of uplink resources to a user equipment, and the user equipment allocates resources based on the resource allocation information and transmits data in uplink.

### SUMMARY

In accordance with an aspect of the present invention, there is provided a resource allocation method of a base station, the method including: allocating resources contiguously or non-contiguously with respect to k (k denotes a natural number greater than or equal to 1) clusters including one or more resource block groups from among the entire resource block groups of a predetermined user equipment in a wireless communication system; and generating resource allocation information including a resource indicator (RIVₜₒₜₐₗ(k)) with respect to the allocated contiguous or non-contiguous resources, which is based on a numerical expression of

$${RIV}_{total} ( k ) = {\sum }_{i = 1}^{k - 1} {RIV}^{max} ( i ) + RIV ( k ) ,$$

wherein RIV(k) denotes a value that indicates a resource indicator with respect to contiguous or non-contiguous resource allocation having k clusters and that begins with 0, RIV(1) includes contiguous resource allocation with frequency hopping and contiguous resource allocation without frequency hopping, and RIV^{max}(i) is a maximum value of RIV(i) with respect to i clusters.

In accordance with another aspect of the present invention, there is provided a resource allocation method of a base station, the method including: allocating resources contiguously or non-contiguously with respect to k (k is a natural number greater than or equal to 1) clusters including one or more resource block groups from among the entire resource block groups of a predetermined user equipment in a wireless communication system; and generating control information including a contiguous or non-contiguous resource allocation field that expresses resource allocation information with respect to the allocated contiguous or non-contiguous resources, wherein when a contiguousness/non-contiguousness distinguishing field included in the control information expresses contiguous resource allocation, the control information expresses contiguous resource allocation information using a range used for contiguous resource allocation with respect to a field value of the contiguous resource allocation field, and expresses a part of the non-contiguous resource allocation information using the remaining range that is not used for the contiguous resource allocation, and when the contiguousness/non-contiguousness distinguishing field expresses non-contiguous resource allocation, the control information expresses another part of the non-contiguous resource allocation information using the entire range with respect to a field value of the non-contiguous resource allocation field, which is obtained by adding a single bit to the contiguous resource allocation field.

In accordance with another aspect of the present invention, there is provided a resource allocation information processing method of a user equipment, the method including: receiving, from a base station, control information including contiguous or non-contiguous resource allocation information that is information for allocating resources contiguously or non-contiguously with respect to k (k is a natural number greater than or equal to 1) clusters including one or more resource block groups from among the entire resource block groups of a predetermined user equipment, and that includes a resource indicator (RIVₜₒₜₐₗ(k)) with respect to the allocated contiguous or non-contiguous resources, which is based on

$${RIV}_{total} ( k ) = {\sum }_{i = 1}^{k - 1} {RIV}^{max} ( i ) + RIV ( k ) ;$$

and interpreting the contiguous or non-contiguous resource allocation information from the received control information, wherein RIV(k) denotes a value that indicates a resource indicator with respect to contiguous or non-contiguous resource allocation having k clusters and that begins with 0, RIV(1) includes contiguous resource allocation with frequency hopping and contiguous resource allocation without frequency hopping, and RIV^{max}(i) is a maximum value of RIV(i) with respect to i clusters.

In accordance with another aspect of the present invention, there is provided a resource allocation information processing method of a user equipment, the method including: receiving control information that includes a contiguous or non-contiguous resource allocation field that contiguously or non-contiguously allocates resources with respect to k (k is a natural number greater than or equal to 1) clusters including one or more resource block groups from among the entire resource block groups of a predetermined user equipment, and expresses resource allocation information associated with the allocated contiguous or non-contiguous resources; and interpreting the contiguous or non-contiguous resource allocation information from the received control information, wherein, when a contiguousness/non-contiguousness distinguishing field included in the control information expresses contiguous resource allocation, the control information expresses contiguous resource allocation information using a range used for contiguous resource allocation with respect to a field value of the contiguous resource allocation field, and expresses a part of the non-contiguous resource allocation information using the remaining range that is not used for the contiguous resource allocation, and when the contiguousness/non-contiguousness distinguishing field included in the control information expresses non-contiguous resource allocation, the control information expresses another part of the non-contiguous resource allocation information using the entire range with respect to a field value of the non-contiguous resource allocation field, which is obtained by adding a single bit to the contiguous resource allocation field.

### BRIEF DESCRIPTION OF DRAWINGS

FIG. 1 is a block diagram illustrating a wireless communication system according to embodiments of the present invention;

FIG. 2 is a conceptual diagram of a resource allocation method according to an embodiment of the present invention;

FIG. 3 illustrates coefficients for expressing non-contiguous resource allocation including 2 clusters used for a non-contiguous resource allocation method according to another embodiment of the present invention;

FIG. 4 illustrates that two clusters of (c) of FIG. 3 are expressed by 4 coefficients;

FIG. 5 illustrates coefficients for expressing non-contiguous resource allocation including 3 clusters used for a non-contiguous resource allocation method according to another embodiment of the present invention;

FIG. 6 illustrates that three clusters of FIG. 4 are expressed by 6 coefficients;

FIG. 7 illustrates an example of a non-contiguous resource allocation method according to another embodiment of the present invention;

FIG. 8 illustrates that k clusters are expressed by 2k coefficients;

FIG. 9 is a flowchart illustrating a configuration of a PDCCH;

FIG. 10 is a block diagram of a base station that generates control information of a downlink according to another embodiment of the present invention;

FIG. 11 is a flowchart illustrating PDCCH processing;

FIG. 12 is a block diagram of a user equipment according to another embodiment of the present invention;

FIG. 13 illustrates a non-contiguous resource allocation method that expresses k clusters by allocating j resource areas from a total of n resource block groups by limiting a range of j and combining allocation of k−1 clusters in a range of j−2;

FIG. 14 illustrates a process that determines an m value based on a predetermined amount of bits required during resource allocation of 2 non-contiguous clusters;

FIG. 15 illustrates a process that determines an m value based on a predetermined amount of bits required during resource allocation of 3 non-contiguous clusters in a form in which two clusters and three clusters are combined;

FIG. 16 illustrates a form of an information payload format of a control channel;

FIG. 17 illustrates a range of each resource allocation in a case in which resource allocation indication of each resource indicator of a resource allocation field is assigned with a single numbering system during contiguous and non-contiguous resource allocation additionally including frequency hopping.

FIG. 18 illustrates ranges of a resource allocation field value for expressing contiguous and non-contiguous resource allocation in Table 3; and

FIG. 19 illustrates a form of an information payload format of a control channel that maintains compatibility with (A) of FIG. 16 and expresses contiguous and non-contiguous resource allocation.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In the present specifications, a “resource block group” refers to a set of successive resource blocks. For example, a number of the entire resource block groups with respect to a downlink system band including N_{RB}^{DL} resource blocks may be given as

$${N}_{RB}^{DL} / P .$$

In this example, P is 1 or a natural number greater than or equal to 2. Therefore, when P=1, a resource block group indicates each resource block. When P≧2, a resource block group indicates a set of P resource blocks. In the latter case, when a number of resource blocks is 100 and P=4, a number of resource block groups is 25.

FIG. 1 illustrates a wireless communication system according to embodiments of the present invention.

The wireless communication system may be widely installed so as to provide various communication services, such as a voice service, packet data, and the like.

Referring to FIG. 1, the wireless communication system includes a User Equipment (UE) 10 and a Base Station (BS) 20. The UE 10 and the BS 20 use various power allocation methods, which will be described below.

Throughout the specifications, the user equipment 10 may be an inclusive concept indicating a user terminal utilized in wireless communication, including a UE (User Equipment) in WCDMA, LTE, HSPA, and the like, and an MS (Mobile Station), a UT (User Terminal), an SS (Subscriber Station), a wireless device, and the like in GSM.

The base station 20 or a cell may refer to a station where communication with the user equipment 10 is performed, and may also be referred to as a Node-B, an eNB (evolved Node-B), a BTS (Base Transceiver System), an access point, and the like.

That is, the base station 20 or the cell may be construed as an inclusive concept including a partial area covered by a BSC (Base Station Controller) in CDMA, a NodeB of WCDMA, and the like, and may be a concept including various coverage areas such as a mega cell, a macro cell, a micro cell, a pico cell, a femto cell, a communication range of a relay node, and the like.

In the specifications, the user equipment 10 and the base station 20 are used as two inclusive transceiving subjects, which are to embody the technology and technical concepts described in the specifications, and may not be limited to a predetermined term or word.

The wireless communication system may utilize varied multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, OFDM-CDMA, and the like.

Uplink transmission and downlink transmission may be performed based on a TDD (Time Division Duplex) scheme that performs transmission based on different times, or to based on an FDD (Frequency Division Duplex) scheme that performs transmission based on different frequencies.

An embodiment of the present invention may be applicable to resource allocation in asynchronous wireless communication that is advanced through GSM, WCDMA, and HSPA, to be LTE and LTE-advanced, and may be applicable to resource allocation in synchronous wireless communication that is advanced through CDMA and CDMA-2000, to be UMB. Embodiments of the present invention may not be limited to a specific wireless communication field, and may be applicable to all technical fields to which a technical idea of the present invention is applicable.

Hereinafter, resource allocation will be inclusively described, and coefficients of resource indication values (RIVs) according to various embodiments, a method of expressing resource indication values using the coefficients, a method of transmitting a PDCCH which is one of the messages including the resource indication values, a processing method thereof, and apparatuses thereof will be described.

In the wireless communication system, one of the basic principles of wireless access is shared channel transmission, that is, dynamic sharing of time-frequency resources in user equipments. The base station 20 may control allocation of uplink resource allocation and downlink resource allocation.

In an LTE system which is one of the wireless communication systems, data transmitted from the user equipment 10 to the base station 20 is carried by a resource block group designated by resource allocation determined by the base station 20, and is transmitted. The base station 20 informs the user equipment 10 of the same using a DCI format of a PDCCH (Physical Downlink Control Channel) which is a downlink control channel. This process is referred to as an Uplink Scheduling grant or simply as a PUSCH grant.

A predetermined field of the format informs the user equipment 10 of a predetermined area in an uplink frame format to which data is to be carried, and the predetermined field is referred to as a resource allocation field. Resource allocation indicated by the resource allocation field is processed based on a resource block group (RBG: Resource Block Group) unit. The resource allocation field expresses resource allocation as binary values in a predetermined range, based on various forms, and informs the user equipment 10 of the same.

The user equipment 10 which is a reception side may interpret a resource allocation field in a detected PDCCH DCI format. The user equipment 10 interprets the resource allocation field, and transmits data to the base station 20 through a data channel, that is, a PUSCH.

Although the resource allocation method has been described by exemplifying an LTE system which is one of the wireless communication systems, the present invention may not be limited thereto. Therefore, a detailed resource allocation scheme or configuration is not limited to the described LTE system, and is construed based on resource allocation scheme or configuration generally described in the present specifications.

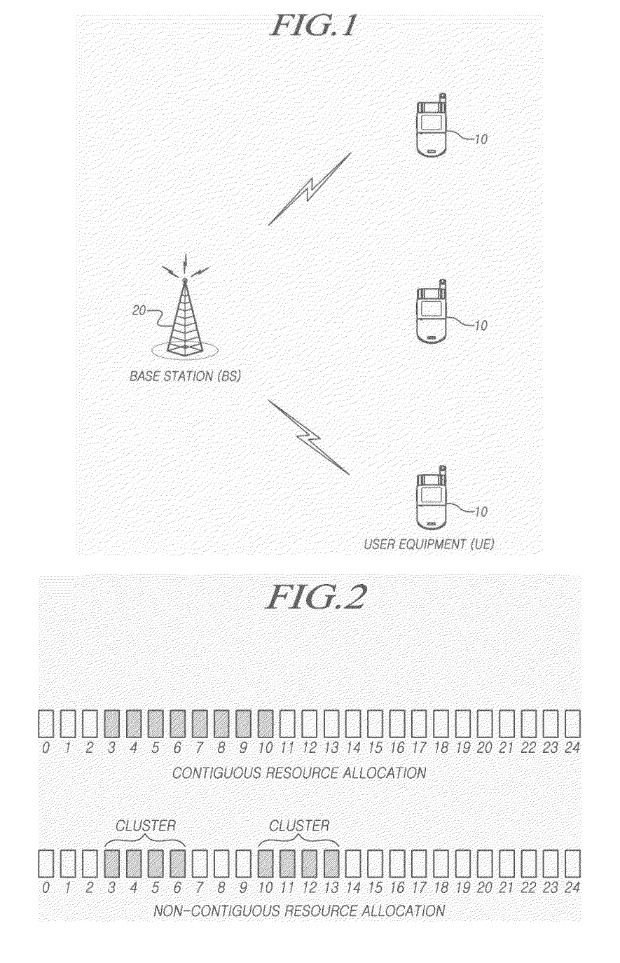

FIG. 2 is a conceptual diagram of a resource allocation method according to an embodiment of the present invention.

For resource allocation in an uplink, a resource allocation method according to an embodiment of the present invention may allocate contiguous resource block groups to the user equipment 10 as shown in the upper portion of FIG. 2 and may allocate non-contiguous resource block groups to the user equipment 10 as shown in the lower portion of FIG. 2, when the entire resource is formed of n resource block groups (n=25 in FIG. 2). The former case is referred to as contiguous resource allocation and the latter case is referred to as non-contiguous resource allocation. The former case may reduce payload of control information for uplink resource allocation, and the latter case may have a gain from a perspective of effective resource allocation.

As described in the lower portion of FIG. 2, each of the contiguous resource allocation areas in non-contiguous resource allocation is referred to as a cluster.

The base station 20 may perform non-contiguous resource allocation or contiguous resource allocation to connected user equipments 10. The base station 20 may perform non-contiguous allocation first, and then may perform contiguous allocation with respect to the user equipment 10, and vice verse.

When a number of clusters is 2 or 3, the non-contiguous resource allocation has most of the performance gain that the non-contiguous resource allocation may have. However, the present invention may not be limited thereto, and may use 4 or more clusters from a perspective of resource allocation efficiency associated with contiguous resource allocation. Hereinafter, descriptions will be provided by exemplifying a case in which a number of clusters is 2 or 3. However, in the present invention, it may be generalized into a case in which a number of clusters is k (k is a natural number greater than or equal to 2). In this example, each cluster includes one or more resource block groups.

Resource allocation has been inclusively described. Hereinafter, a resource indication value of contiguous resource allocation will be described.

Uplink scheduling grant or PUSCH grant may use DCI format 0 from among PDCCH DCI formats which are control channels, but the present invention may not be limited thereto. For example, to support a resource allocation method according to an embodiment of the present invention, in addition to a control channel for uplink scheduling grant or PUSCH grant, another channel, for example, a data channel, may be used. Although a control channel is used, another control channel in addition to a PDCCH is used, and although a PDCCH is used, another format in addition to the DCI format 0 or a newly defined format may be used. That is, is those may be used for downlink scheduling for PDSCH grant. Also, a combination of the described schemes may be used.

A control field that indicates information associated with resource allocation that the base station 20 informs the user equipment of, for example, a resource allocation field, may express a possible case of resource allocation using an integer value in a predetermined range. Expressing the possible case of resource allocation using an integer value in a predetermined range as described above corresponds to a resource indication value (RIV: Resource Indication Value). Hereinafter, an information field through which the base station 20 informs the user equipment 10 of information associated with resource allocation is referred to as s resource allocation field, and an integer value in a predetermined range is referred to as a resource indication value, but the present specifications may not be limited thereto.

The resource allocation field of contiguous resource allocation in the upper portion of FIG. 2 may be formed of a resource indication value (RIV_{LTE}(L_{CRBs},RBₛₜₐᵣₜ,N_{RB}^{DL}) corresponding to a starting point (Starting Resource Block, RBₛₜₐᵣₜ) of a resource block group and a length of a virtual contiguous resource blocks (length in terms of virtually contiguously allocated resource blocks, L_{CRBs}). In this example, RIV_{LTE}(L_{CRBs}, RBₛₜₐᵣₜ, N_{RB}^{DL} may be expressed as follows.

if (L_{CRBs}−1)≦└N_{RB}^{DL}/2┘ then

RIV_{LTE}(L_{CRBs},RBₛₜₐᵣₜ,N_{RB}^{DL})=N_{RB}^{DL}(L_{CRBs}−1)+RBₛₜₐᵣₜ

else

RIV_{LTE}(L_{CRBs},RBₛₜₐᵣₜ,N_{RB}^{DL})=N_{RB}^{DL}(N_{RB}^{DL}−L_{CRBs}+1)+(N_{RB}^{DL}−1−RBₛₜₐᵣₜ) [Equation 1]

where L_{CRBs}≧1 and shall not exceed N_{VRB}^{DL}−RBₛₜₐᵣₜ.

Here, └•┘ denotes a rounding down operation, and indicates the greatest number among numbers that are less than or equal to a number included in └ ┘. N_{VRB}^{DL} denotes a maximum length of the virtual contiguous resource block group. N_{RB}^{DL} denotes a value indicating a number of the entire resource block groups, and corresponds to n. “DL” indicates a downlink, but this may not be limited to the downlink. That is, using “UL”, N_{RB}^{DL or N}_{VRB}^{DL} may be replaced with N_{RB}^{DL} or N_{VRB}^{DL}. Also, “RB” may be replaced with “RBG”.

In this example, when the number of the entire resource block groups is N_{RB}^{DL}, a resource indication value (RIV_{LTE}(L_{CRBs},RBₛₜₐᵣₜ,N_{RB}^{DL})) corresponding to the starting point (Starting Resource Block, RBₛₜₐᵣₜ) of the resource block group and the length of the contiguous resource blocks (length in terms of virtually contiguously allocated resource blocks, L_{CRBs}) has a value in a range from 0 to

$$\frac{{N}_{RB}^{DL} ( {N}_{RB}^{DL} + 1 )}{2} - 1.$$

When N_{RB}^{DL}=n=25, RIV_{LTE}(L_{CRBs},RBₛₜₐᵣₜ,N_{RB}^{DL}) has a value in a range from 0 to 324.

In a case in which the number of entire resource block groups is 25, when the contiguous resource allocation in the upper portion of FIG. 2 having RBₛₜₐᵣₜ=3 and L_{CRBs}=8 is described, RIV_{LTE}(L_{CRBs},RBₛₜₐᵣₜ,N_{RB}^{DL})=N_{RB}^{DL}(L_{CRBs}−1)+RBₛₜₐᵣₜ=178.

A method in which the user equipment 10 that is a receiving side interprets a resource allocation field in a detected PDCCH DCI format 0, and decodes a resource indicator will be described as follows.

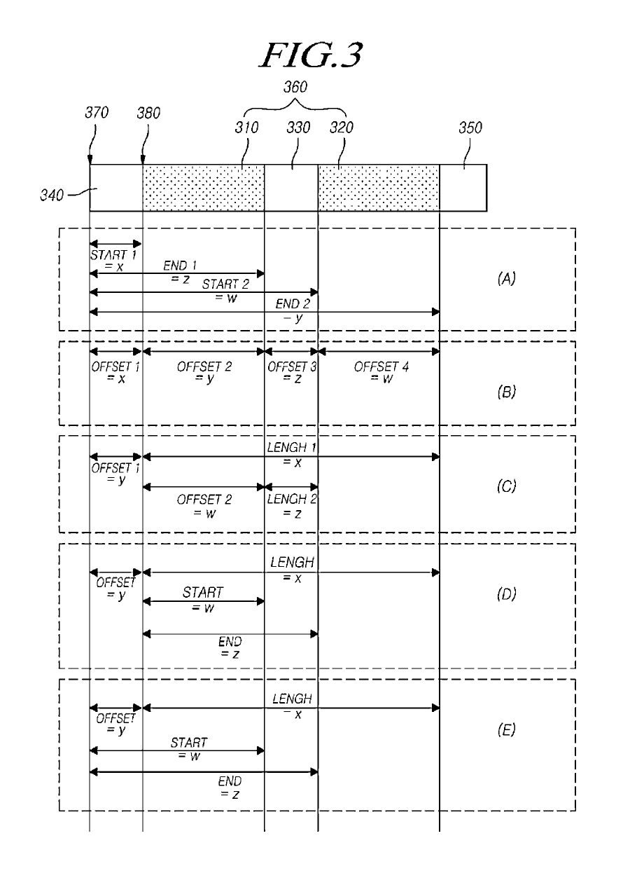

The user equipment 10 which is the receiving side detects an RIV value (=178) from the resource allocation field of the detected PDCCH DCI format 0. L_{CRBs} (=8) is calculated by adding 1 to the quotient of the RIV divided by N_{RB}^{DL} (=25), and RBₛₜₐᵣₜ (=3) is obtained from the remainder (=3). A resource indication value of contiguous resource allocation has been described. Hereinafter, a resource indicator in a resource allocation method of two non-contiguous clusters will be described. In this example, coefficients of resource indicators in the resource allocation method of the 2 non-contiguous clusters will be described with reference to (a) through (e) of FIG. 3, and a concept of expressing two clusters of (C) of FIG. 3 using 4 coefficients will be described.

A resource allocation field of the non-contiguous resource allocation may be formed of a resource indicator expressed using various coefficients, so as to express two or more clusters.

FIG. 3 illustrates coefficients for expressing non-contiguous resource allocation including 2 clusters used for a non-contiguous resource allocation method according to another embodiment of the present invention. Unlike FIG. 2, FIG. 3 does not separately illustrate resource block groups and distinctively illustrates the entire resource block groups, as areas 310 and 320 of resource block groups that are allocated as resources with respect to the entire resource block groups and areas 330, 340, and 350 of resource block groups that are not allocated as resources. The areas 310 and 320 of the resource block groups allocated as resources refer to clusters as described above.

Referring to (a) of FIG. 3, a resource allocation field of non-contiguous resource allocation is formed of a resource indicator (RIV) corresponding to a starting point (Starting Resource Block of the first cluster) and an ending point (Ending Resource Block of the first cluster) of a resource block group of a first cluster 310, and a starting point (Starting Resource Block of the second cluster) and an ending point (Ending Resource Block of the second cluster) of a resource block group of a second cluster 320.

Referring to (a) of FIG. 3, coefficients of the starting points and ending points of the two non-contiguous clusters 310 and 320 for expressing a resource allocation field of non-contiguous resource allocation may be expressed as x, y, z, and w. In this example, a range may be defined so that a coefficient (z) of the ending point of the cluster 310 that is configured earlier has a difference of at least 2 from the starting point (w) of the cluster 320 configured later (a length of non-contiguous part is greater than or equal to 1), and the starting points and the ending points of the clusters 310 and 320 may have identical values, respectively.

Referring to (b) of FIG. 3, the resource allocation field of non-contiguous resource allocation is formed of a resource indicator (RIV) corresponding to four offset values of two non-contiguous clusters 310 and 320. In this example, in a starting point of the entire resource block groups, a first offset indicates a beginning of the first cluster 310 and a second offset indicates an ending of the first cluster 310. In this manner, a third offset and a fourth offset respectively indicate a beginning and an ending of the second cluster 320.

In principle, each offset is given based on an ending of an immediately previous offset, and a range of an offset begins with 0. However, a third value is required to have a value greater than or equal to 1. In this configuration scheme, general k clusters may be expressed by adding two offset coefficients for each cluster.

Referring to (c) of FIG. 3, a resource allocation field of non-contiguous resource allocation is formed of a resource indicator (RIV) corresponding to an offset (y) of the entirety 360 of the resource block groups including two clusters 310 and 320 and the area 330 of resource block groups that exist between the two clusters 310 and 320 and are not assigned with resources, a length (x) of the entirety 360, another offset (w) of the area 330 of the resource block groups that exist between the two clusters 310 and 320 and are not assigned with resources, and a length (z) thereof.

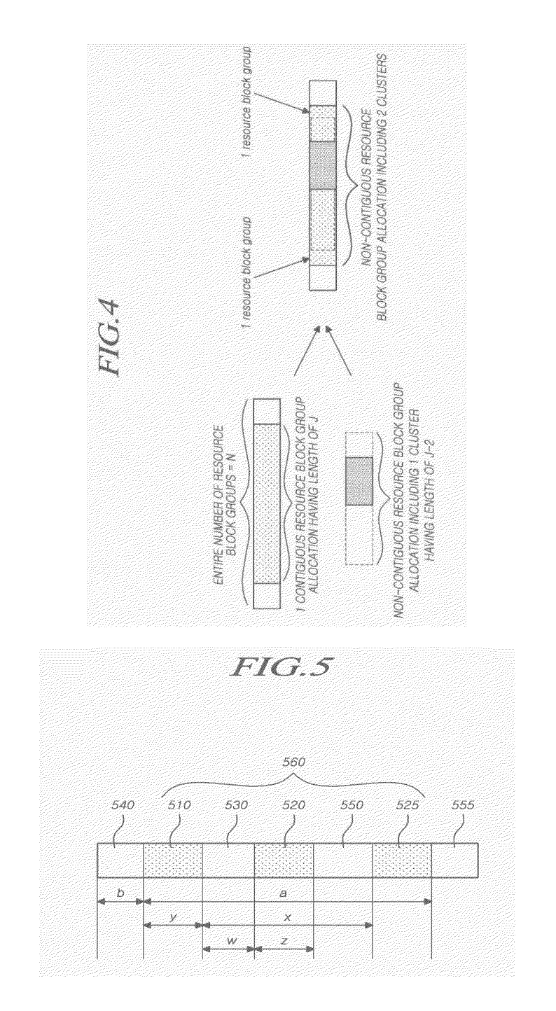

FIG. 4 illustrates a concept of expressing two clusters of (c) of FIG. 3 using 4 coefficients. In this example, to avoid ambiguousness of the drawing, reference numerals used in FIG. 3 are not used in FIG. 4.

Referring to FIG. 4, when a number of the entire resource block groups is n, indication of two clusters may be expressed in a way that a single area to which allocation is not performed is included in contiguous resource block groups having a length of j−2 with respect to contiguous resource block groups having a length of j. This may mean that the area to which allocation is not performed may be allocated between two clusters in the contiguous resource block groups having the length of j−2 included in the contiguous resource block groups having the length of j.

Referring to FIG. 4 together with (c) of FIG. 3, the contiguous resource block groups (the diagram 360 of FIG. 3) having the length of j is expressed by an offset (y) of the contiguous resource block groups 360 having the length of j and a length (x) of the contiguous resource block groups 360, as described in (c) of FIG. 3, in the same manner as a resource indication value (RIV) of a resource allocation field of contiguous resource allocation that has been described with reference to the upper portion of FIG. 2. The area 330 to which allocation is not performed and which exists between the clusters 310 and 320 included in the contiguous resource block groups 360 having the length of j is expressed by another offset (w) of resource block groups and a length (Z) of an area of the resource block groups, which exist between clusters and to which resource allocation is not performed. In this example, to express as a minimum (a length is 1) of the area 330 of the resource block groups to which allocation is not performed, the offset value (w) is given by considering a value (y+1) that is 1 greater than the first offset value (y) as 0 and a starting point.

In other words, the coefficient y is a starting point (offset) of a first resource block group in the contiguous resource block groups 360, x indicates a number of the contiguous resource block groups, and indicates a number of resource block groups in two clusters and a number of resource block groups in which resource allocation is not performed between two clusters, w is calculated as a starting point of resource block groups in which resource allocation is not performed between two clusters when the resource block group of y+1 is indexed into 0, and z is a number of resource block groups in which resource allocation is not performed between 2 clusters.

As an example of non-contiguous resource allocation in the lower portion of FIG. 2, when a number of entire resource block groups is 25, y=3, x=11, w=3, and z=3.

In a case of non-contiguous resource allocation based on the scheme of (c) of FIG. 3 and FIG. 4, when it is assumed that resource allocation is allocated in order of x(x=3, . . . , n), y(y=0, . . . , n−x), z(z=1, . . . , x−2), and w(w=0, . . . , x−z−2), a resource indicator (RIV) of a resource allocation field may be expressed as follows, but this may not be limited thereto.

RIV(2)=RIV₁(x,n)+RIV₂(x,y)+RIV₃(x,z)+RIV₄(w). RIV=0, . . . ,ₙ₊₁C₄−1 [Equation 2]

“2” in RIV(2) indicates that a number of non-contiguous clusters is two, and RIV(2) indicates a resource indicator (RIV) of a resource allocation field of non-contiguous resource allocation with respect to 2 non-contiguous clusters. Hereinafter, “x” in RIV(x) indicates a number of non-contiguous clusters.

In the above expression, RIV₁(x,n) is a function of x and n and indicates a number of resource allocation events until x−1, RIV₂(x,y) is a function of x and y and indicates a number of resource allocation events associated with a change in a value of y, RIV₃(x,z) is a function of x and z and indicates a number of resource allocation events until z−1, and RIV₄(w) is a function of w and indicates a number of resource allocation events associated with a change in a value of w.

When RIV₁(x,n), RIV₂(x,y), RIV₃(x,z), and RIV₄(w) are expressed by n that is a number of the entire resource block groups and 4 coefficients, x, y, w, and z, it is expressed as follows.

$$\vert \begin{matrix}{RIV}_{1} ( x , n ) = {\sum }_{i = 1}^{x - 1} \frac{( n + 1 - i ) ( {i}^{2} - 3 i + 2 )}{2} = \frac{( x - 1 ) ( ( 4 n + 19 ) {x}^{2} + 24 ( n + 1 ) - 3 {x}^{3} - ( 20 n + 38 ) x )}{24} , x = 3 , … , n \\ {RIV}_{2} ( x , y ) = y {\sum }_{i = 1}^{x - 2} i = \frac{( x - 2 ) ( x - 1 ) y}{2} , y = 0 , … , n - x \\ {RIV}_{3} ( x , z ) = {\sum }_{i = 1}^{z - 1} ( x - 1 - i ) = ( x - 1 ) ( z - 1 ) - \frac{z ( z - 1 )}{2} , z = 1 , … , x - 2 \\ {RIV}_{4} ( w ) = {\sum }_{i = 0}^{w} i = w , w = 0 , … , x - z - 2\end{matrix} \qquad [ Equation 3 ]$$

In a case in which the number of the entire resource block groups is 25, when the non-contiguous resource allocation in the lower portion of FIG. 2 having y=3, x=11, w=3, and z=3 is described, RIV₁(x,n)=0, RIV₂(x,y)=11, RIV₃(x,z)=1, and RIV₄(w)=3 and thus, RIV(2)=15.

A resource indicator when a number of non-contiguous clusters is 2 has been described. Hereinafter, a process in which a user equipment that is a receiving side decodes the resource indicator will be described.

The process in which user equipment 10 that is a receiving side interprets a resource allocation field of a detected PDCCH DCI format 0, and decodes a resource indicator will be described as follows.

1) store values of RIV₁(3,n), . . . , RIV₁(n,n) when n resource block groups exist

2) calculate x, that satisfies RIV₁(x_{rcv},n)≦RIV_{rcv}, <RIV₁(x_{rcv}+1,n) in RIV₁(3,n), . . . , RIV₁(n,n) from a received RIV_{rcv}

3) calculate y_{rcv} that satisfies

RIV₂(x_{rcv},y_{rcv})≦RIV_{rcv}−RIV₁(x_{rcv},n)<RIV₂(x_{rcv},y_{rcv}+1)

4) calculate z_{rcv} that satisfies

RIV₃(x_{rcv},z_{rcv})≦RIV_{rcv}−RIV₁(x_{rcv},n)−RIV₂(x_{rcv},y_{rcv})<RIV₃(x_{rcv},z_{rcv}+1)

5) calculates

w_{rcv}=RIV_{rcv}−RIV₁(x_{rcv},n)−RIV₂(x_{rcv},y_{rcv})−RIV₃(x_{rcv},z_{rcv})

x, y, z, and w that are coefficients of starting points and ending points of the two non-contiguous clusters 310 and 320 which express a resource indicator of a resource allocation field of the non-contiguous resource allocation illustrated in (a) of FIG. 3, and four offset values that express a resource indicator of a resource allocation field of the non-contiguous resource allocation of (b) of FIG. 3 may be expressed as a transformation relationship with coefficients that express a resource indicator of resource allocation fields of the non-contiguous resource allocation of (c) of FIG. 3.

For example, the coefficients of the starting points and the ending points of two non-contiguous clusters that express the resource indicator of the resource allocation field of the non-contiguous resource allocation illustrated in (a) of FIG. 3 may have a relationship of x(START₁)=y, z(END₁)=y+w+1, w(START₂)=y+w+z+1, and y(END₂)=x+y. Also, the relationship may be expressed as x=END₂−START₁+1, y=START₁, z=START₂−END₁−1, and w=END₁−START₁. Here, each coefficient may have a range of 0˜n−1.

As another example, 4 offsets that express the resource indicator of the resource allocation field of the non-contiguous resource allocation illustrated in (b) of FIG. 3 has a relationship of x(offset1)=y, y(offset2)=w+1, z(offset3)=z, and w(offset4)=x−w−z−1.

Referring to (d) of FIG. 3, a resource allocation field of non-contiguous resource allocation is formed of a resource indicator (RIV) corresponding to an offset (y) of the entirety 360 of the resource block groups including two clusters 310 and 320 and the area 330 of resource block groups that exist between the two clusters 310 and 320 and are not assigned with resources, a length (x) of the entirety 360, a starting point (w) and an ending point (z) of the area 330 that exist between the two clusters 310 and 320 and are not assigned with resources. In this example, the starting point (w) and the ending point (z) of the area that exists between two clusters and is not assigned with resources use a starting point 380 of the resource block groups of a first cluster as a base.

Referring to (e) of FIG. 3, a resource allocation field of non-contiguous resource allocation is formed of a resource indicator (RIV) corresponding to an offset (y) of the entirety 360 of the resource block groups including two clusters 310 and 320 and the area 330 of resource block groups that exist between the two clusters 310 and 320 and are not assigned with resources, a length (x) of the entirety 360, a starting point (w) and an ending point (z) of the area 330 that exists between the two clusters 310 and 320 and is not assigned with resources. In this example, the starting point (w) and the ending point (z) of the area 330 that exists between two clusters 310 and 320 and is not assigned with resources use a starting point 370 of the entire resource block groups of a first cluster as a base.

As described above, coefficients that express a resource indicator of a resource allocation field of non-contiguous resource allocation described with reference to (a) through (e) of FIG. 3 have a transposition relationship.

A resource indicator of a resource allocation method of two non-contiguous clusters has been described. Hereinafter, a resource indicator of a resource allocation method of 3 non-contiguous clusters will be described.

FIG. 5 illustrates coefficients that express non-contiguous resource allocation having 3 clusters used for a non-contiguous resource allocation method according to another embodiment of the present invention. Unlike FIG. 2, FIG. 5 does not illustrate resource block groups and distinctively illustrates the entire resource block groups, as areas 510, 520, and 525 of resource block groups allocated as resources and areas 530, 540, 550, and 555 of resource block groups that are not allocated as resources. The areas 510, 520, and 525 of the resource block groups allocated as resources refer to clusters as described above. Referring to FIG. 5, a resource allocation field of non-contiguous resource allocation forms a resource indicator (RIV) from an offset (b) of a resource block group of an area 560 including three clusters 510, 520, and 525 and areas 530 and 550 of resource block groups that are not assigned with resources, a length (a) of the entire area 560, x, y, z, and w indicating offsets and a length of the areas 530 and 550 that are not assigned with resources in the entire area 560.

FIG. 6 illustrates a concept of expressing three clusters of FIG. 5 with 6 coefficients. In this example, to clarify the drawing, reference numerals used in FIG. 5 are not included in FIG. 6. Referring to FIG. 6, two clusters included inside indicate resource block groups which exist among three clusters, and to which allocation is not performed.

In this example, contiguous resource block groups having a length of j are expressed by the offset (b) of the resource block group and the length (a) of the contiguous resource blocks, in the same manner as the resource indication value (RIV) of the resource allocation field of the contiguous resource allocation that is described with reference to the upper portion of FIG. 2. To express three clusters, an area that is not assigned with resources of a resource allocation area exists in a form of two clusters, which may be expressed as an RIV value indicating two clusters. In this example, y indicating an entire offset of the area to which resource allocation is not performed has a value by indexing a resource block of b+1 into 0.

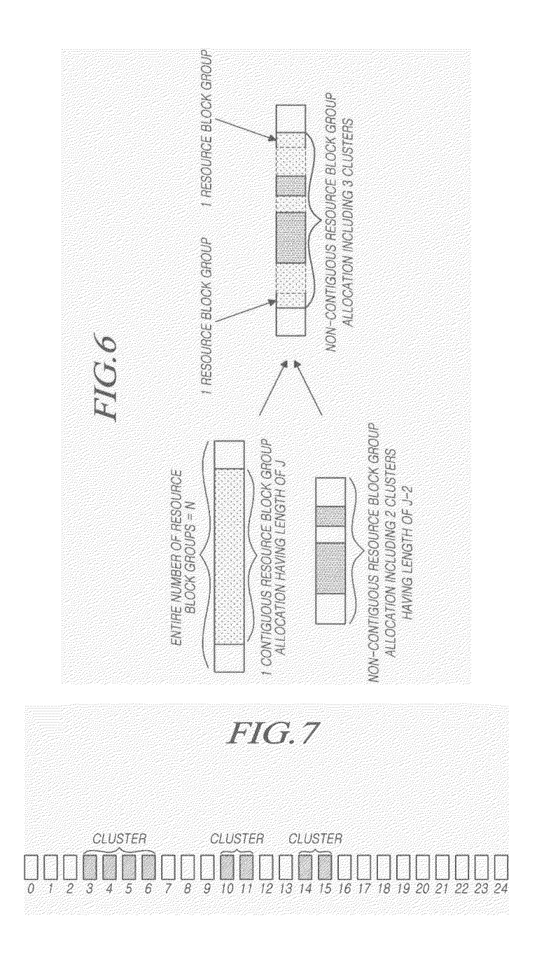

FIG. 7 is an example of a non-contiguous resource allocation method according to another embodiment of the present invention.

Referring to FIG. 7, a number of the entire resource block groups is 25, and b=3, a=13, y=3, x=7, w=2, and z=2. The base station 20 allocates 4 resource block groups out of the entire resource block groups, and the resource allocation is performed through three non-contiguous clusters with respect to a predetermined user equipment 10, in the same manner as the lower portion of FIG. 2. A number of the allocated resource block groups (8 out of a total of 25) are equal, but has a gain from a perspective of resource allocation.

When it is assumed that resource allocation is performed in order of a(a=5, . . . , n), b(b=0, . . . , n−a), x(x=3, . . . , a−2), y(y=0, . . . , a−2−x), z(z=1, . . . , x−2), and w(w=0, . . . , x−z−2), a resource indicator (RIV) of a resource allocation field of non-contiguous allocation performed based on a scheme of FIG. 7 is expressed as follows. That is, when a number of the entire resource block groups is n, and a value is allocated in order of the length (a) of the entire area including three clusters and the resource block groups that exist among three clusters and are not assigned with resources, the offset (b) of the entire area, and the offset and length (x, y, z, and w) indicating the area to which resources are not allocated in the entire area, the resource indicator (RIV) is expressed as follows.

RIV(3)=RIV₁(a,n)+RIV₂(a,b)+RIV₃(x,a−2)+RIV₄(x,y)+RIV₅(x,z)+RIV₆(w), [Equation 4]

RIV=0, . . . , ₙ₊₁C₆−1

In the above expression, RIV₁(a,n) is a function of a and n and indicates a number of resource allocation events until a−1, RIV₂(a,b) is a function of a and b and indicates a number of resource allocation events associated with a change in a value of b, RIV₃(x,a−2) is a function of x and a−2 and indicates a number of resource allocation events until x−1, and RIV₄(x,y) is a function of x and y and indicates a number of resource allocation events associated with a change in a value of y, RIV₅(x,z) is a function of x and z and indicates a number of resource allocation events until z−1, and RIV₆(w) is a function of w and indicates a number of resource allocation events associated with a change in a value of w.

When RIV₁(a,n), RIV₂(a,b), RIV₃(x,a−2), RIV₄(x,y), RIV₅(x,z), and RIV₆(w) are expressed using n that is a number of the entire resource block groups and 6 coefficients, a, b, x, y, w, and z, they are expressed as follows.

$${RIV}_{1} ( a , n ) = \frac{\begin{matrix}\begin{matrix}2 ( n + 11 ) a ( a + 1 ) ( 2 a - 1 ) \\ ( 3 {( a - 1 )}^{2} + 3 ( a - 1 ) - 1 ) +\end{matrix} \\ 10 ( 35 n + 85 ) a ( a - 1 ) \\ ( 2 a - 1 ) + 24 \cdot 60 ( n + 1 ) ( a - 1 )\end{matrix}}{24 \cdot 60} - \frac{\begin{matrix}\begin{matrix}5 {{a}^{2} ( a + 1 )}^{2} ( 2 {( a - 1 )}^{2} + 2 ( a - 1 ) - 1 ) + \\ 15 ( 10 n + 45 ) {{a}^{2} ( a - 1 )}^{2} +\end{matrix} \\ 24 \cdot 30 ( 50 n + 74 ) a ( a - 1 )\end{matrix}}{24 \cdot 60} , \\ a = 5 , … , n \\ {RIV}_{2} ( a , b ) = \frac{( x - 4 ) ( x - 3 ) ( x - 2 ) ( x - 1 ) b}{24} , \\ b = 0 , … n - a \\ {RIV}_{3} ( x , a - 2 ) = \frac{( x - 1 ) ( \begin{matrix}\begin{matrix}( 4 ( a - 2 ) + 19 ) {x}^{2} + \\ 24 ( ( a - 2 ) + 1 ) - 3 {x}^{3} -\end{matrix} \\ ( 20 ( a - 2 ) + 38 ) x\end{matrix} )}{24} , \\ x = 3 , … , a - 2 \\ {RIV}_{4} ( x , y ) = \frac{( x - 2 ) ( x - 1 ) y}{2} , \\ y = 0 , … , a - 2 - x \\ {RIV}_{5} ( x , z ) = ( x - 1 ) ( z - 1 ) - \frac{z ( z - 1 )}{2} , \\ z = 1 , … , x - 2 \\ {RIV}_{6} ( w ) = w , w = 0 , … , x - z - 2 \qquad [ Equation 5 ]$$

A resource indicator of a resource allocation method of two or three non-contiguous clusters has been described. Hereinafter, a resource indicator of a resource allocation method of k non-contiguous clusters, which is generalized those examples, will be described.

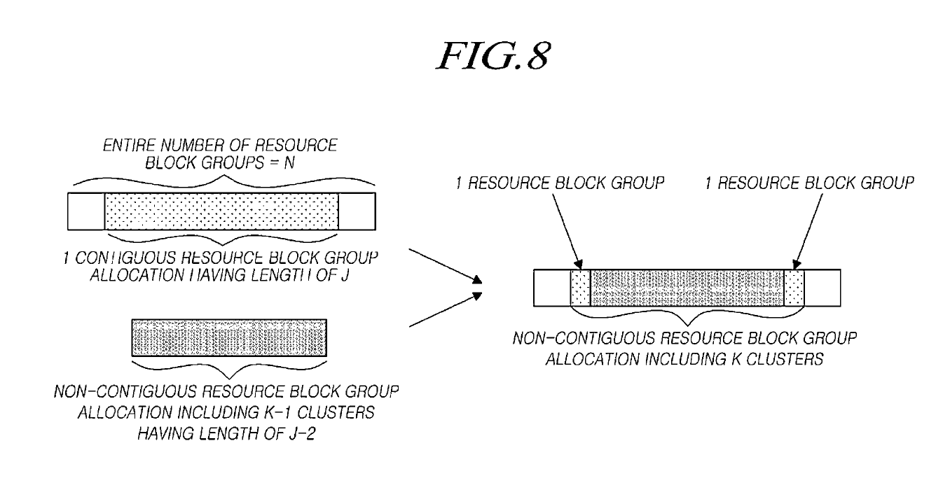

FIG. 8 illustrates a concept of expressing k clusters with 2k coefficients. Allocation of resource block groups with respect to k clusters is generally illustrated as shown in FIG. 8. That is, a configuration of an RIV value that expresses k non-contiguous clusters may be expressed by 2 coefficients (an offset and a length) indicating the entire area and k−1 non-contiguous area to which resource allocation is not performed in the entire area. In other words, when a number of the entire resource block groups is n, the non-contiguous resource allocation group allocation having k clusters may be expressed using 1 contiguous resource block group allocation having a length of j and non-contiguous resource block group allocation including k−1 clusters and having a length of j−2. In this example, a range of j corresponds to n which is the number of the entire resource block groups.

The non-contiguous area including k−1 clusters to which resource allocation is not performed may be expressed by an RIV value indicating k−1 clusters, and an RIV value associated with k clusters may be recursively configured. In the recursive configuration, for the area including k−1 clusters to which resource allocation is not performed, included inside the entire area, an RIV value is designated within a range that is 2 less than a length indicating the entire area, and accordingly, a starting point of each offset and a range of a length are determined. In addition to the non-contiguous resource configuration as described above and the scheme described in FIG. 3, various RIV configurations for non-contiguous resource allocation may be possible.

Resource configuration may be expressed based on a general scheme which is different from the above described scheme. When resource allocation is expressed from coefficients x₁, x₂, . . . , xₖ (expressed by k coefficients), a method of indicating a resource indicator (RIV(x₁, x₂, . . . , xₖ, n)) of a general resource allocation field in the present specifications will be described as follows.

RIV(x₁,x₂, . . . ,xₖ,n)=RIV₁(x₁,n)+RIV₂(x₁,x₂,n)+ . . . +RIVₖ(x₁,x₂, . . . ,xₖ,n) [Equation 6]

In the above expression, x₁ and x₂, . . . , xₖ respectively indicate an offset, a length of resource block groups, and at least one of a starting point and an ending point of a predetermined cluster, and n denotes a number of entire resource block groups. Also, RIV₁(x₁,n) is a function of x₁ and n and indicates a number of all available combinations (under a condition of x₁=x₁^{fixed}) in a range in which coefficients x₂, . . . , xₖ are available when x₁=x₁^{fixed}, and RIV₂(x₁,x₂,n) is a function of x₁ and x₂,n and indicates a number of all available combinations (under a condition of x₁=x₁^{fixed} and x₂=x₂^{fixed}) in a range in which coefficients x₃, . . . , xₖ are available when x₁=x₁^{fixed} and x₂=x₂^{fixed}. When it is generalized, RIV(x₁, x₂, . . . , xₖ, n) is a function of x₁ and x₂, . . . , xₖ,n and indicates a number of all available combinations (under a condition of x₁=x₁^{fixed}, x₂=x₂^{fixed}, . . . , and xᵢ=xᵢ^{fixed}) in a range in which coefficients xᵢ₊₁, . . . , xₖ are available when x₁=x₁^{fixed}, x₂=x₂^{fixed}, . . . , and xᵢ=xᵢ^{fixed}. Here, to enable a value of RIV(x₁, x₂, . . . , xₖ, n) to begin with 0, x=^{fixed}−1 may be used as opposed to using xᵢ=xᵢ^{fixed}.

When a resource indicator (RIV(x₁, x₂, . . . , xₖ, n)) of a resource allocation field is expressed in this manner, transmission of a message including an information field, for example, a resource allocation field, that is, a process of including a resource allocation field in the PDCCH DCI format 0 and transmitting the same to the user equipment 10 so that the user equipment 10 receives the message and performs decoding, will be described as follows.

1) allocate i=1 (indexing of i may begin with 0, that is, i=0)

2) calculate xᵢ=xᵢ^{dec} that satisfies a condition of RIVᵢ(x₁^{dec}, x₂^{dec}, . . . , xᵢ₋₁^{dec}, x₁, . . . , xₖ, n)≦RIV_{rcv} with respect to a received RIV_{rcv} value and enables RIVᵢ(x₁^{dec}, x₂^{dec}, . . . , xᵢ₋₁^{dec}, xᵢ, . . . , xₖ, n) to be closest to RIV_{rcv}

3) RIV_{rcv}=RIV_{rcv}−xᵢ^{dec}

4) i=i+1

5) terminate when i>k, otherwise return to 2).

For example, although a resource indicator is expressed with 4 offsets with respect to 2 non-contiguous clusters in (b) of FIG. 3, the resource indicator may be expressed with 2k offsets with respect to k non-contiguous clusters through generalization. In this example, 2 pairs out of 2k offsets may express a starting point and an ending point of a predetermined cluster.

In this manner, other schemes of FIG. 3 may express a resource indicator with respect to k non-contiguous clusters using Equation 6.

A scheme of expressing k non-contiguous clusters by a resource indicator has been described. Hereinafter, a scheme of commonly expressing contiguous and non-contiguous clusters by a resource indicator will be described.

A method of configuring a resource indicator of a resource allocation field of contiguous resource allocation has been described with reference to the upper portion of FIG. 2, and a method of configuring a resource indicator of a resource allocation field of non-contiguous resource allocation has been described with reference to the lower portion of FIG. 2 through FIG. 7. In this example, resource allocation indication of each resource indicator of a resource allocation field of contiguous and non-contiguous resource allocation may be assigned through a different numbering system or a single numbering system.

For example, when numbering of 1 through k cluster resource allocations is performed, numbering of a resource indicator of a resource allocation field is performed as follows.

RIV(k) is defined as a resource indicator (RIV) of a resource allocation field having k clusters. In this example, it is assumed that a form of RIV (k) begins with 0.

$${RIV}_{total} = {\sum }_{i = 1}^{k - 1} ( {RIV}^{ma x} ( i ) + 1 ) + RIV ( k ) \qquad [ Equation 7 ]$$

Here, RIV^{max}(i) denotes a maximum value of a resource allocation RIV value having i clusters.

Numbering of the resource indicator of the resource allocation field corresponds to a scheme of sequentially arranging an RIV having a small number of clusters from 0 and increasing a value of numbering.

When it is assumed that a form of RIV(k) begins with 1, descriptions is provided as follows.

$${RIV}_{total} ( k ) = {\sum }_{i = 1}^{k - 1} {RIV}^{ma x} ( i ) - RIV ( k ) \qquad [ Equation 8 ]$$

Hereinafter, in a case of contiguous resource allocation and resource allocation of 2 non-contiguous clusters, an example of numbering a resource indicator of a resource allocation field using a single numbering system will be described as follows.

As described above, a resource indicator of a resource allocation field of contiguous resource allocation may be expressed as Equation 1, and a resource indicator of a resource allocation field of resource allocation of 2 non-contiguous clusters may be expressed as Equations 2 and 3.

In this example, the resource indicators of the resource allocation field of the contiguous and non-contiguous resource allocation may be expressed by a single numbering system based on Equation 8, as shown below.

$${RIV}_{total} ( 2 ) = \{ \begin{matrix}{RIV}_{LTE} ( z , w , n ) ( continuguous ) \\ RIV ( 2 ) + \frac{n ( n + 1 )}{2} ( non \text{-} contiguous )\end{matrix} \\ OR \\ {RIV}_{total} ( 2 ) = \{ \begin{matrix}{RIV}_{LTE} ( z , w , {n}^{′} ) ( continuguous ) \\ RIV ( 2 ) + \frac{{n}^{′} ( {n}^{′} + 1 )}{2} ( non \text{-} contiguous )\end{matrix} \qquad [ Equation 9 ]$$

Here, z=L_{CRBs} and w=RBₛₜₐᵣₜ. n′=N_{RB}^{DL} or N_{RB}^{UL}. n=N_{RBG}^{DL} or N_{RBG}^{UL}. That is, it may be a unit of a resource block or a resource block group. That is, in a second expression, allocation is performed based on a resource block unit with respect to contiguous allocation, and allocation is based on a resource block group with respect to non-contiguous resource allocation. Also, other coefficients have been described through Equation 1 through 3.

In the above expression, the resource indicator RIV_{LTE}(z,w,n) of the resource allocation field of the contiguous resource allocation is from 0 to (n(n+1)/2−1), and the resource indicator RIV(2) of the resource allocation field of the non-contiguous resource allocation is from n(n+1)/2 and thus, both are provided using a single numbering system.

The numbering configuration enables the resource indicator of the resource allocation field of the contiguous resource allocation to maintain backward compatibility, and simultaneously, provides an advantageous in that another allocation of a bit for distinguishing a cluster is not required.

A scheme of separately numbering each resource indicator of a resource allocation field of contiguous and non-contiguous resource allocation requires additional allocation of at least 1 bit to distinguish a cluster. However, the scheme of numbering the resource indicators of the resource allocation field of contiguous and non-contiguous resource allocation through a single numbering system may not require the additional bit allocation.

In Equation 8, RIV(k) may be obtained from a different numbering system (that is configured by a different system, which is different from a general numbering system based on a cumulative system proposed in the present invention), as opposed to the same numbering system. A summation formula may be obtained by overlapping a k value or inserting a value smaller than an original k value into the different numbering system, and a value of i may not begin with 1 and may begin with a value greater than or equal to 1.

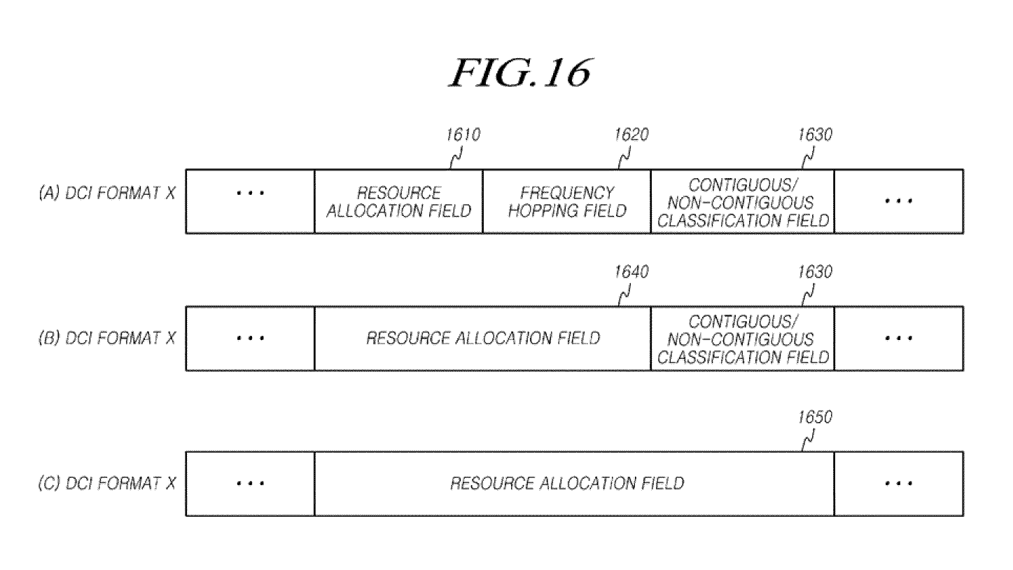

FIG. 16 illustrates a form of an information payload format of a control channel.

A physical downlink control channel (Physical Downlink Control Channel, PDCCH) that is one of the control channels that transmit control information is distinguished by various DCI formats (Downlink Control Indication format, DCI format), and provides user equipment specific (UE specific) control information. When the user equipment specific control information is transmitted, information for decoding a physical downlink shared channel (Physical Uplink Shared Channel, PUSCH) or a physical uplink shared channel (Physical Uplink Shared Channel, PUSCH) from a perspective of a user equipment is provided, and simultaneously, control information required for communication is provided to the user equipment.

Referring to (A) of FIG. 6, the DCI format x (x is a current or future DCI format number), for example, the DCI format 0, may include a resource allocation field 1610, a frequency hopping field 1620, and a contiguousness/non-contiguousness distinguishing field 1630. In this example, the DCI format 0 is exemplified as the DCI format x, and the same scheme may be applied to any current or future DCI format.

The resource allocation field 1610 includes resource allocation information used for transmission of uplink or downlink data. In this example, a scheme of expressing resource allocation information in the resource allocation field 1610 may be the above described resource allocation scheme, a resource allocation scheme to be described, or any current or future resource allocation scheme.

The frequency hopping field 1620 indicates whether frequency hopping is performed or not, using a predetermined number of bits, for example, a 1 bit frequency hopping bit, as shown in Table 1.

TABLE 1

| Frequency hopping bit | Information |
|---|---|
| 1 | frequency hopping |
| 0 | no frequency hopping |

The contiguousness/non-contiguousness distinguishing field 1630 distinctively determines whether downlink or uplink resource allocation corresponds to contiguous/non-contiguous resource allocation using a predetermined number of bits, for example, a contiguousness/non-contiguousness distinguishing bit of 1 bit.

TABLE 2

| Contiguousness/non-contiguousness | |
|---|---|
| distinguishing bit | Information |
| 1 | non-contiguous resource allocation |
| 0 | contiguous resource allocation |

For the contiguous resource allocation, frequency hopping may be helpful for improving the performance. However, for the non-contiguous resource allocation, frequency hopping may not be helpful for improving the performance. That is, for the contiguous resource allocation, resource allocation needs to be distinguished by taking into consideration frequency hopping. However, for the non-contiguous resource allocation, frequency hopping does not need to be taken into consideration.

Therefore, as illustrated in (B) of FIG. 16, the contiguousness/non-contiguousness distinguishing bit 1630 is maintained in the DCI format x and a frequency hopping bit may be used as the resource allocation field 1640 in a case of the non-contiguous resource allocation.

A number of clusters of non-contiguous resource allocation, that is, k is limited to, for example, 2, non-contiguous resource allocation is performed in a form of a resource block group (RBG: Resource Block Group) including several resource blocks (RB: Resource Block), and a non-contiguous resource allocation field (the diagram 1614 of (B) of FIG. 16) is configured by adding a frequency hopping bit (1 bit) to a contiguous resource allocation field (the diagram 1610 of (A) of FIG. 16) in the DCI format x and thus, the non-contiguous resource allocation may be expressed without extending a number of bits in the resource allocation field in the DCI format x.

When the DCI format x is the DCI format 0, the contiguousness/non-contiguousness distinguishing field 1630 may utilize a residual bit since the DCI format 1A requires at least one more bit than the DCI format 0 and at least one bit is always residual in the DCI format 0. That is, during a blind decoding process, the DCI format 0 and the DCI format 1A are processed in the same decoding process, and are blind-decoded by assuming that each band has a predetermined size. After determining the predetermined size, the DCI format 0 and the DCI format 1A are distinguished through a distinguishing bit inside a PDCCH (a bit for distinguishing the DCI format 0 and the DCI format 1A). As described above, the DCI format 0 and the DCI format 1A are designed to have the same size, and the DCI format 1A requires at least one more bit than the DCI format 0 by taking into consideration the use of an internal field of each of the DCI format 0 and the DCI format 1A and thus, the DCI format 0 always has an at least 1 bit residual. In other words, when the DCI format x is the DCI format 0, the residual bit may be used as the contiguousness/non-contiguousness distinguishing field 1630.

Hereinafter, by taking into consideration a case in which an amount of bits required of the non-contiguous resource allocation field 1640 is 1 bit greater than a length of the contiguous resource allocation field 1610 by using a resource block group (RBG) and restricting a number of clusters, resource allocation indication of each resource indicator of a resource allocation field during contiguous and non-contiguous resource allocation including an example of frequency hopping may be assigned through a single numbering system.

In the described embodiment, a frequency hopping has not been taken into consideration when resource allocation indication of each resource indicator of a resource allocation field is provided through a single numbering system during contiguous and non-contiguous resource allocation. However, when the resource allocation indication is provided through a single numbering system, frequency hopping may be taken into considered. That is, the single numbering system of the resource allocation field described above may be extended as shown in Equation 10.

$${RIV}_{total} ( 2 ) = \{ \begin{matrix}0 \sim \frac{n ( n + 1 )}{2} - 1 & \begin{matrix}no frequency \\ hopping contiguous\end{matrix} \\ \frac{n ( n + 1 )}{2} \sim \frac{n ( n + 1 )}{2} + {2}^{Q} - 1 & \begin{matrix}frequency \\ hopping contiguous\end{matrix} \\ \frac{n ( n + 1 )}{2} + {2}^{Q} \sim {2}^{Q + 2} - 1 & non \text{-} contiguous\end{matrix} \qquad [ Equation 10 ]$$

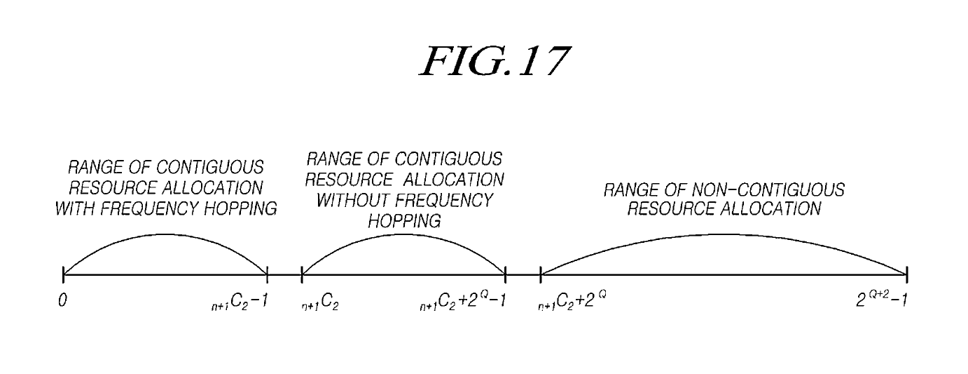

FIG. 17 illustrate ranges of each resource allocation when resource allocation indication of each resource indicator of a resource allocation field is provided through a single numbering system during contiguous and non-contiguous resource allocation additionally including frequency hopping.

Referring to Equation 10 and FIG. 17, a range of contiguous resource allocation without frequency hopping is allocated to

$$0 \sim \frac{n ( n + 1 )}{2} - 1 ,$$

a range of contiguous resource allocation with frequency hopping is allocated to

$$\frac{n ( n + 1 )}{2} \sim \frac{n ( n + 1 )}{2} + {2}^{Q} - 1 ,$$

and a range of non-contiguous resource allocation is allocated to

$$\frac{n ( n + 1 )}{2} + {2}^{Q} \sim \frac{n ( n + 1 )}{2} + {2}^{Q} + {}_{{n}^{′} + 1}^{}{C}{}_{4}^{} - 1.$$

### When

$$\frac{n ( n + 1 )}{2} + {2}^{Q} + {}_{{n}^{′} + 1}^{}{C}{}_{4}^{} - 1 > {2}^{Q + 2} - 1 ,$$

a limit is 2^{Q+2}−1.

Here, n denotes a number of uplink or downlink resource blocks.

$$\frac{n ( n + 1 )}{2} = {}_{n + 1}^{}{C}{}_{2}^{}$$

denotes a maximum range of contiguous resource allocation. _{n′+1}C₄ denotes a maximum range of non-contiguous resource allocation including two clusters. Here,

$${n}^{′} = \frac{n}{P} ,$$

and P denotes a size of a resource block group (RBG). Also,

$$Q = ⌈ {log}_{2} ( \frac{n ( n + 1 )}{2} ) ⌉ ,$$

and ┌a┐ is an integer that is greater than and close to a. In the above descriptions, 2^{Q+2} denotes a sum of lengths of a frequency hopping bit (1 bit), a resource allocation field (2^{Q} bit), and a contiguousness/non-contiguousness distinguishing bit (1 bit).

For example, a number of resource blocks, n, is one of the natural numbers greater than 0, and a size of a resource block group (RBG), P, is one of the natural numbers greater than 1 and less than n, but this may not be limited thereto.

All possible combinations when k clusters are allocated to the given n resource blocks are known as ₙ₊₁^{C}₂ₖ. In this example, when k is 1, it indicates contiguous resource allocation. When k is 2, it indicates non-contiguous resource allocation with respect to 2 clusters.

For example, when n=7, a maximum range of contiguous resource allocation is

$$\frac{n ( n + 1 )}{2} = {}_{n + 1}^{}{C}{}_{2}^{} = 28$$

and a number of bits of contiguous resource allocation field is 5 bits. As illustrated in (B) of FIG. 16, when a frequency hopping bit (1 bit) is added, a number of bits of the resource allocation field 164 is 6 bits. In this case, a size of a resource block group (RBG) is P=1, and a range of non-contiguous resource allocation is _{n′+1}C₄=70 and has 7 bits. Therefore although a frequency hopping bit is added to a contiguous resource allocation field, non-contiguous resource allocation information corresponding to a range of 64˜69 among a range of 0˜69 may not be indicated.

Accordingly, a total of 8 bits may be required in the DCI format x of (B) of FIG. 16, so as to indicate contiguous and non-contiguous resource allocation with 7 bits in the resource allocation field 1640 and to indicate whether it corresponds to contiguous resource allocation or non-contiguous resource allocation with 1 bit in the contiguousnes s/non-contiguousness distinguishing field 1630.

As illustrated in (C) of FIG. 16, the DCI format x may express contiguous resource allocation with frequency hopping, contiguous resource allocation without frequency hopping, and non-contiguous resource allocation of an uplink or a downlink in the resource allocation field 1650 using a single numbering system.

When the DCI format x expresses contiguous resource allocation with frequency hopping, contiguous resource allocation without frequency hopping, and non-contiguous resource allocation of an uplink or a downlink in the resource allocation field 1650 using a single numbering system, the ranges of the resource allocation with frequency hopping, the contiguous resource allocation without frequency hopping, and non-contiguous resource allocation may be expressed as shown in Equation 11.

$${RIV}_{total} ( 2 ) = \{ \begin{matrix}0 \sim 27 & nofrequencyhopping contiguous \\ 28 \sim 59 & frequencyhopping contiguous \\ 60 \sim 127 & non \text{-} contiguous\end{matrix} \qquad [ Equation 11 ]$$

The scheme of applying a contiguousness/non-contiguousness distinguishing bit may be extended by applying a single numbering system for expressing contiguous and non-contiguous resource allocation in the DCI format x. The extended scheme may be advantageous in that it maintains compatibility with the scheme of using the contiguousness/non-contiguousness distinguishing bit illustrated in (A) of FIG. 16.

The scheme of applying the contiguousness/non-contiguousness distinguishing bit by applying a single numbering system for expressing contiguous and non-contiguous resource allocation in the DCI format x may be expressed as shown in Table 3.

TABLE 3

| Contiguous/non- | | | |
|---|---|---|---|
| contiguous | Frequency | resource allocation field value | |
| allocation | hopping | Range used | Range not used |
| Contiguous resource allocation (distinguishing bit = 0) | No frequency hopping (frequency hopping bit = 0) | $0 \text{∼} \frac{n ( n + 1 )}{2} - 1$ | $\frac{n ( n + 1 )}{2} \text{∼} {2}^{Q}$ |
| | Frequency | 0~2^{Q} − 1 | none |
| | hopping | | |
| | (frequency | | |
| | hopping bit = 1) | | |

| | |
|---|---|
| Non-contiguous | 0~_{n′+1}C₄ − 1 |
| resource allocation | |
| (distinguishing | |
| bit = 1) | |

In Table 3, as described with reference to Equation 10,

$$Q = ⌈ {log}_{2} ( \frac{n ( n + 1 )}{2} ) ⌉$$

and ┌a┐ denotes an integer that is greater than and close to a.

In this example, a range that is not used for contiguous resource allocation without frequency hopping is

$$\frac{n ( n + 1 )}{2} \sim {2}^{Q} - 1.$$

Therefore, the range of

$${2}^{Q} - \frac{n ( n + 1 )}{2}$$

remains unused during the contiguous resource allocation without frequency hopping. The range of

$${2}^{Q} - \frac{n ( n + 1 )}{2}$$

that remains since it is not used during the contiguous resource allocation without frequency hopping may be used for non-contiguous resource allocation.

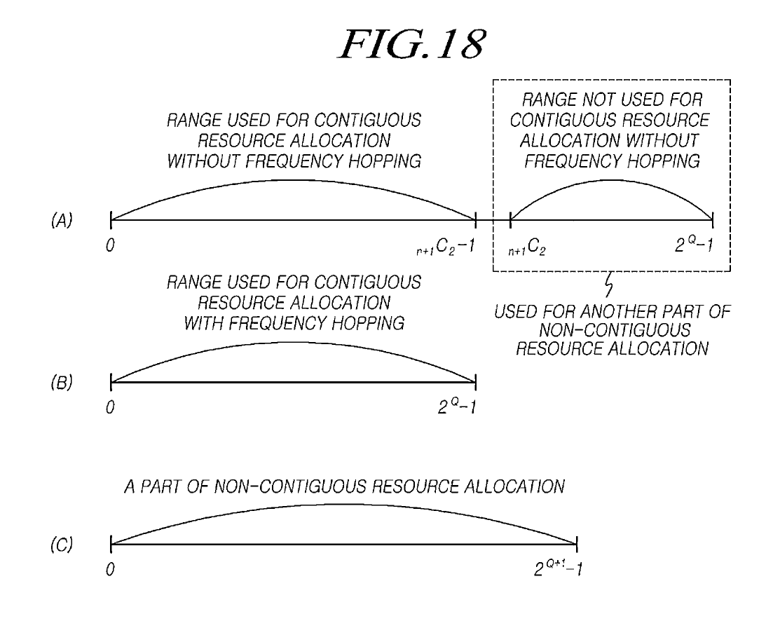

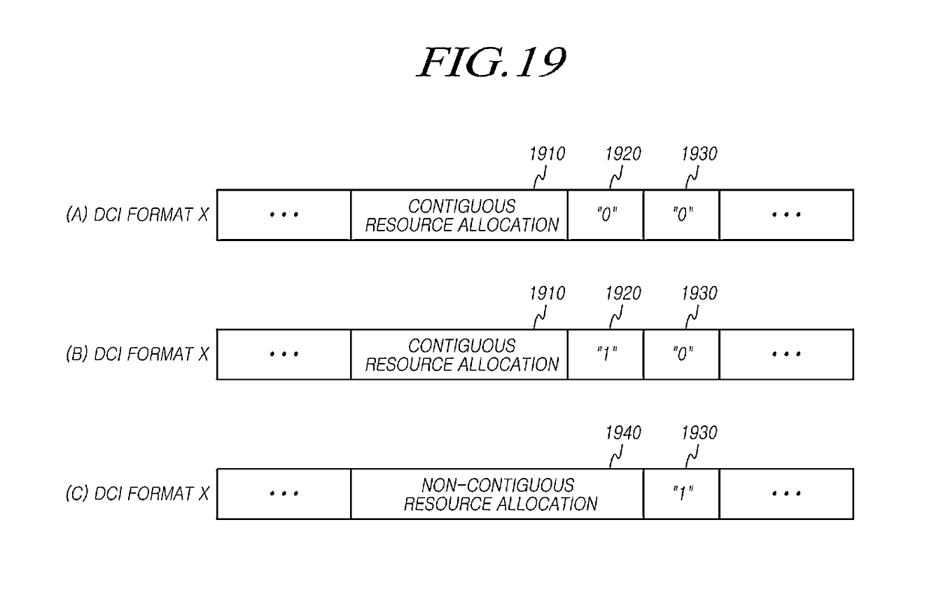

(A) through (C) of FIG. 18 illustrate ranges of resource allocation field values for expressing contiguous and non-contiguous resource allocation in Table 3. (A) through (C) of FIG. 19 illustrate forms of an information payload format of a control channel, which maintains compatibility with (A) of FIG. 16 and expresses contiguous and non-contiguous resource allocation.

Referring to (A) of FIG. 18 and (A) of FIG. 19, a field value of a frequency hopping field 1920 is “0”, a field value of a contiguousness/non-contiguousness distinguishing field (1930) is “0”, and a range of a field value of a contiguous resource allocation field 1910 of contiguous resource allocation without frequency hopping is

$$0 \sim \frac{n ( n + 1 )}{2} - 1.$$

In this manner, referring to (B) of FIG. 18 and (B) of FIG. 19, a field value of the frequency hopping field 1920 is “1”, a field value of the contiguousness/non-contiguousness distinguishing field 1930 is “0”, and contiguous resource allocation information with frequency hopping is expressed in the contiguous resource allocation field 1910 for contiguous resource allocation with frequency hopping.

Also, referring to (C) of FIG. 18 and (C) of FIG. 19, a field value of the contiguousness/non-contiguousness distinguishing field 1930 is “1” and a field value of a non-contiguous resource allocation field 1940 in which a frequency hopping field and a contiguous resource allocation field are integrated is 0˜_{n′+1}C₄−1 for non-contiguous resource allocation. In this example, 2^{Q+1}<_{n′+1}C₄, and a range of 0˜2^{Q+1}−1 is used as a field value of the non-contiguous resource allocation field 1940 and a range of 2^{Q+1}˜_{n′+1}C₄ is not supported.

When 2^{Q+1}<_{n′+1}C₄ and the field value of the non-contiguous resource allocation field 1940 is incapable of expressing all of non-contiguous resource allocation information, a remaining range of

$$\frac{n ( n + 1 )}{2} \sim {2}^{Q} - 1$$

that is not used for contiguous resource allocation without frequency hopping as illustrated in (A) of FIG. 18 may be used for the non-contiguous resource allocation. In other words, as illustrated in (A) of FIG. 18, it is understood that the field value of the contiguousness/non-contiguousness distinguishing field 1930 being “0” and the field value of the resource allocation field 1910 being

$$\frac{n ( n + 1 )}{2} \sim {2}^{Q} - 1$$

may express non-contiguous resource allocation information.

When 2^{Q+1}<_{n′+1}C₄ and the field value of the non-contiguous resource allocation field 1940 is incapable of expressing all of the non-contiguous resource allocation information, a remaining range of

$$\frac{n ( n + 1 )}{2} \sim {2}^{Q} - 1$$

that is not used for the contiguous resource allocation without frequency hopping as illustrated in (A) of FIG. 18 is used for non-contiguous resource allocation, which will be described again as shown in Table 4 below.

TABLE 4

| Contiguous/ | | | |
|---|---|---|---|
| non-contiguous | Frequency | Resource allocation field value | |
| allocation | hopping | Range used | Range not used |
| Contiguous resource allocation (distinguish- ing bit = 0) | No frequency hopping (frequency hopping bit = 0) | $0 \text{∼} \frac{n ( n + 1 )}{2} - 1$ | $\frac{n ( n + 1 )}{2} \text{∼} {2}^{Q} - 1$ allocate a part of 2^{Q+1}~_{n′+1}C₄ that is not supported in non-contiguous resource allocation |
| | Frequency | 0~2^{Q} − 1 | none |
| | hopping | | |
| | (frequency | | |
| | hopping bit = 1) | | |

| | |
|---|---|
| Non- | 0~_{n′+1}C₄ − 1 |
| contiguous | (0~up to 2^{Q+1} − 1 is available) |
| resource | |
| allocation | |
| (distinguish- | |
| ing bit = 1) | |

Referring to Table 4, a range of 0˜ up to 2^{Q+1}−1 is used as a field value of the non-contiguous resource allocation field 1940, and a range of 2^{Q+1}˜_{n′+1}C₄ is not supported. As illustrated in (A) of FIG. 18, the remaining range

$$\frac{n ( n + 1 )}{2} \sim {2}^{Q} - 1$$

that is not used for contiguous resource allocation without frequency hopping may be used as a part of 2^{Q+1}˜_{n′+1}C₄ that is not supported in the non-contiguous resource allocation.

For example, when a case in which n=7 and non-contiguous resource allocation using two clusters is applied, it is described as shown in Table 5.

TABLE 5

| | | Resource allocation | |
|---|---|---|---|
| | | field value | |
| Contiguous/non- | Frequency | Range | |
| contiguous allocation | hopping | used | Range not used |
| Contiguous resource | No frequency | 0-27 | 28~31-> allocate a |
| allocation | hopping | | part of 64~70 that |
| (distinguishing bit = | (frequency | | is not supported in |
| 0) | hopping bit = 0) | | the non-contiguous |
| | | | resource allocation |
| | | | (that is, |
| | | | 28->64, 29->65, |
| | | | 30->66, and |
| | | | 31->67) |
| | Frequency | 0~31 | none |
| | hopping | | |
| | (frequency | | |
| | hopping bit = 1) | | |

| | |
|---|---|
| Non-contiguous | 0~69 (0~ up to 63 is available, designation |
| resource allocation | for 64~67 is required and a remaining |
| (distinguishing bit = 1) | range of above contiguous resource |
| | allocation is used) |

Referring to Table 5, a range of 0˜ up to 63 is used as the field value of the non-contiguous resource allocation field 1940 and a range of 64˜69 is not supported. A range of 28˜31 that is not used for contiguous resource allocation without frequency hopping is used as a range of 64˜67 which is a part of the range 64˜69 which is not supported in the non-contiguous resource allocation. In other words, the range of 28˜31 that is not used for contiguous resource allocation without frequency hopping is used as 64˜67 which is a part of the range that is not supported in the contiguous resource allocation. That is, 2864, 2965, 3066, and 3167.

In the above described embodiment, a case corresponding to the range of 68˜69 that is not supported in the non-contiguous resource allocation may not be indicated and thus, a gain may be relatively small. As illustrated in (A) of FIG. 16, a scheme of separately expressing contiguous or non-contiguous allocation information is incapable of indicating all of the non-contiguous resource allocation. Conversely, when they are expressed using a single numbering system, the non-contiguous resource allocation may be expressed within a given resource allocation field.

Schemes (algorithms) that express contiguous or non-contiguous resource allocation information in a resource allocation field in the described examples may not be limited to the schemes that have been described or are to be described, and may correspond to a current or future scheme that expresses resource allocation information.

A resource indicator of a contiguous and non-contiguous resource allocation method in common has been described. Hereinafter, partial substitution for a resource indicator of a resource allocation field will be described.

When an existing 3GPP LTE contiguous allocation resource indicator is used for a partial configuration of a resource indicator for a configuration of a non-contiguous resource indicator in a case of two or more clusters, such as a resource indicator (RIV) of a resource allocation method of 2 non-contiguous clusters and a resource indicator (RIV) of a resource allocation method of 3 non-contiguous clusters and thus, a decoding complexity may be decreased in a receiving end. A resource indicator configures a numbering system that indicates resource allocation of non-contiguous clusters based on contiguous resource allocation, such as a resource indicator (RIV) of a resource allocation method of 2 non-contiguous clusters and a resource indicator (RIV) of a resource allocation method of 3 non-contiguous clusters, but numbering may be actually in a different form from the existing LTE 3GPP contiguous allocation resource indicator.

In other words, a calculated value of at least one of RIV₁ through RIV_{K} in Equation 6 is replaced with a resource indicator (RIV) of contiguous resource allocation corresponding to a starting point (Starting Resource Block, RBₛₜₐᵣₜ) of a resource block group and a length of contiguous virtual resource blocks (length in terms of virtually contiguously allocated resource blocks, L_{CRBs}).

For example, when a number of non-contiguous clusters is 2 and 3, an example of applying a part of RIV(2) and RIV(3) as a resource indicator of a contiguous resource allocation field will be described as follows.

In RIV (2), z=1, . . . , x−2, w=0, . . . x−z−2 and thus, RIV₃(x,z)+RIV₄(w)=RIV_{LTE}(x−2, z, w) Here, z=1, . . . , x−2,

In RIV(3), RIV₅(x,z)+RIV₆(w)=RIV_{LTE}(x−2, z, w). Here, z=1, . . . , x−2, w=0, . . . , x−z−2.

Through the above described method, a backward compatibility may be improved, and simultaneously, it is advantageous from a perspective of a decoding complexity.

As described above, uplink scheduling grant or PUSCH grant may use the DCI format 0 from among PDCCH DCI formats which are control channels. However, to support the resource allocation method, another channel, for example, a data channel, in addition to a control channel may be used for uplink scheduling grant or PUSCH grant. Also, although a control channel is used, another control channel in addition to a PDCCH may be used. Although a PDCCH is used, another format in addition to the DCI format 0, a newly defined format, or a DCI format for a downlink may be used.

Hereinafter, uplink scheduling grant or PUSCH grant performed using the PDCCH DCI format 0 will be described, but this may not be limited thereto.

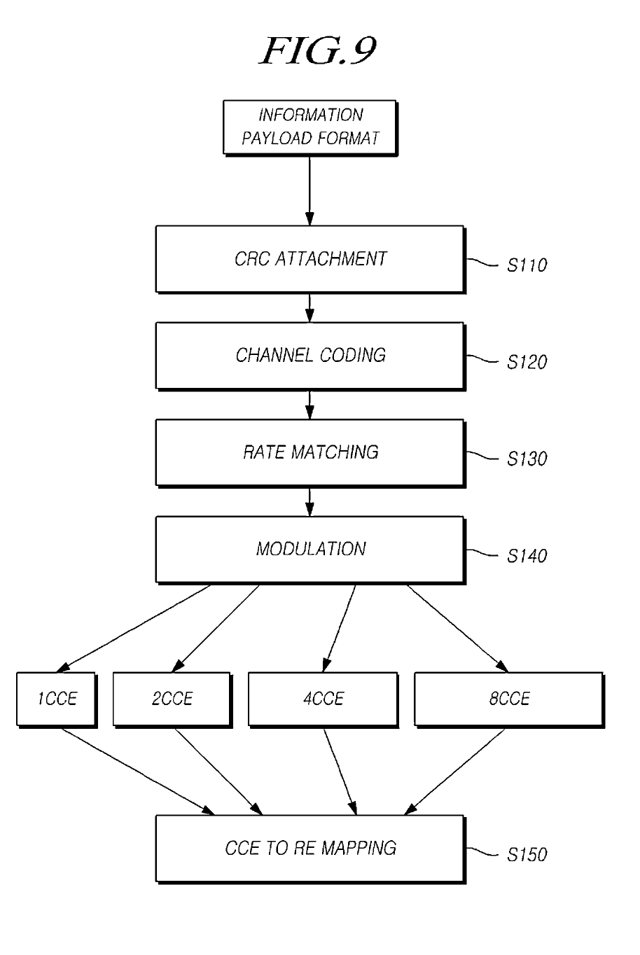

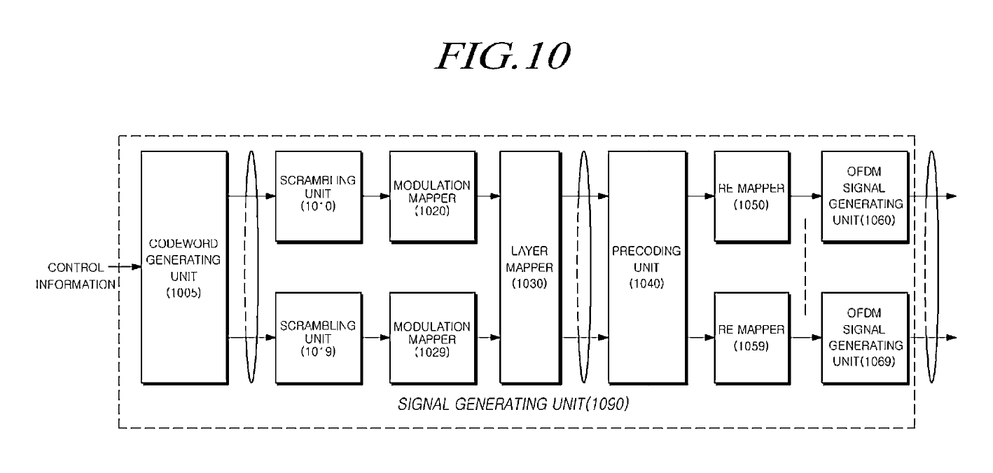

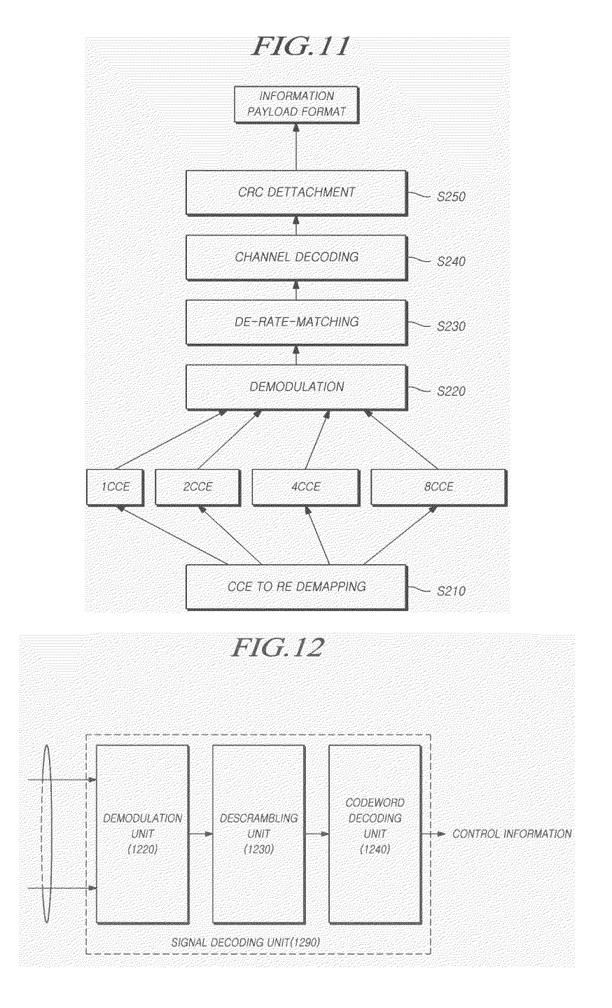

FIG. 9 is a flowchart illustrating a configuration of a PDCCH according to another embodiment of the present invention, FIG. 10 is a flowchart illustrating a PDCCH processing according to another embodiment of the present invention, and FIG. 11 is a block diagram of a transmitting device of a base station and a receiving device of a user equipment.

Referring to FIGS. 1 through 9, the base station 20 configures a PDCCH payload based on an information payload format which is to be transmitted to a user equipment. A length of the PDCCH payload may be various based on the information payload format. The information payload format may be a DCI format.

As described above, the DCI format 0 may be configured by expressing a resource indicator (RIV) in a resource allocation field of the DCI format 0. In this example, the resource allocation field may express the resource indicator (RIV) based on the scheme described with reference to FIGS. 2 through 8, but descriptions thereof will be omitted to avoid a duplication. For example, a resource indicator may be expressed as RIV(x₁, x₂, . . . , xₖ, n)=RIV₁(x₁,n)+RIV₂(x₁,x₂,n)+ . . . +RIVₖ(x₁, x₂, . . . , xₖ, n) of Equation 6 (here, x₁ and x₂, . . . , xₖ indicate an offset, a length of resource block groups, and at least one of a starting point and an ending point of a predetermined cluster, and n indicates a number of entire resource block groups).

Also, resource allocation information may be expressed in the resource allocation field using a single numbering system as described with reference to FIGS. 16 through 19, Equations 10 and 11, or Tables 3 through 5, and resource allocation information may be expressed by applying a contiguousness/non-contiguousness distinguishing bit through applying a single numbering system.

For example, referring to Equation 10 and FIG. 17, a range of contiguous resource allocation without frequency hopping is allocated to a range of

$$0 \sim \frac{n ( n + 1 )}{2} - 1 ,$$

a range of contiguous resource allocation with frequency hopping is allocated to a range of

$$\frac{n ( n + 1 )}{2} \sim \frac{n ( n + 1 )}{2} + {2}^{Q} - 1 ,$$

and a range of non-contiguous resource allocation is allocated to

$$\frac{n ( n + 1 )}{2} \sim {2}^{Q} \sim \frac{n ( n + 1 )}{2} + {2}^{Q} + {}_{{n}^{′} + 1}^{}{C}{}_{4}^{} - 1.$$

As another example, referring to Table 4 and (A) through (C) of FIG. 18, when 2^{Q+1}<_{n′+1}C₄ and a field value of the non-contiguous resource allocation field 1940 is incapable of expressing all of non-contiguous resource allocation information, a range of

$$\frac{n ( n + 1 )}{2} \sim {2}^{Q} - 1$$

that is not used for contiguous resource allocation without frequency hopping may be used for the non-contiguous resource allocation, as illustrated in (A) of FIG. 18.

In this example, other information payload formats may exist as DCI formats.

In step S110, a CRC (Cyclic Redundancy Check) for error detection is added to each PDCCH payload. An identifier (referred to as a RNTI (Radio Network Temporary Identifier)) is masked on a CRC based on an owner or a purpose of a PDCCH.

In step S120, coded data is generated by performing channel coding on the control information to which the CRC is added.

In step S130, rate matching is performed based on a CCE aggregation level that is allocated to a PDCCH format.

In step S140, modulated symbols are generated by modulating the coded data.

In step S150, modulated symbols are mapped into a physical resource element (CCE to RE mapping).

The method of transmitting control information described with reference to FIG. 9 may be generalized, which will be described as follows. A base station may transmit control information to a user equipment by adding a CRC(Cyclic Redundancy Check) for error detection to the control information including resource allocation information expressed as RIV(x₁, x₂, . . . , x_{k, n)=RIV}₁(x₁,n)+RIV₂(x₁,x₂,n)+ . . . +RIVₖ(x₁, x₂, . . . , xₖ, n) of Equation 6, generating coded data by performing channel coding on the control information to which the CRC is added, generating modulated symbols by modulating the coded data, and mapping the modulated symbols into a physical resource element.

FIG. 10 is a block diagram of a base station that generates control information of a downlink according to another embodiment of the present invention.

Referring to FIGS. 1 and 10, a signal generating unit 1090 includes a codeword generating unit 1005, scrambling units 1010, . . . , and 1019, modulation mappers 1020, . . . , and 1029, a layer mapper 1030, a precoding unit 1040, RE mappers (resource element mappers) 1050, . . . , and 1059, and OFDM signal generating units 1060, . . . , and 1069, which may exist as separate modules, or may work as a single module by combining two or more modules.

A CRC (Cyclic Redundancy Check) is added to control information that includes resource allocation information expressed as RIV(x₁, x₂, . . . , xₖ, n)=RIV₁(x₁,n)+RIV₂(x₁,x₂,n)+ . . . +RIVₖ(x₁, x₂, . . . , xₖ, n) of Equation 6 as described above, and the control information is input into the signal generating unit 1090.

The control information to which the CRC is added is generated to be an OFDM signal through the codeword generating unit 1005, the scrambling units 1010 1010, . . . , 1019, the modulation mappers 1020, . . . , 1029, the layer mapper 1030, the precoding unit 1040, the RE mappers (resource element mappers) 1050, . . . , and 1059, and the OFDM signal generating units 1060, . . . , and 1069, and is transmitted to a user equipment through an antenna.

In the OFDM signal generating process of FIG. 10, precoding is omitted in a process of generating a PDCCH which is an embodiment that has been described with reference to FIG. 9 and thus, an input and an output of the precoding may be the same. Also, multiple paths may not be required after a codeword is generated. A TCC (Tailbiting convolutional coding) may be used for generating a PDCCH control channel, and a RM (rate matching) related operation may be applied.

FIG. 11 is a flowchart illustrating a PDCCH processing.

Referring to FIG. 1 and FIG. 11, in step S210, the user equipment 10 demaps a physical resource element into a CCE (CCE to RE demapping).

In step S220, the user equipment 10 is not aware of a CCE aggregation level at which the user equipment 10 is required to receive a PDCCH and thus, may perform demodulation of a CCE aggregation level that a payload corresponding to a reference DCI format associated with a transmission mode may have.

In step S230, the user equipment 10 performs de-rate-matching on the demodulated data based on the corresponding payload and corresponding CCE aggregation level.

In step S240, coded data is decoded based on a code rate, and CRC check is performed for error detection. When an error does not occur, it indicates that the user equipment 10 detects a corresponding PDCCH. When an error occurs, the user equipment 10 continuously performs blind decoding with respect to another CCE aggregation level or another DCI format.

In step S250, the user equipment 10 that detects the corresponding PDCCH removes the CRC from the decoded data so as to obtain control information.

Particularly, the DCI format 0 is detected and uplink scheduling grant included in the DCI format 0 is interpreted. In this example, when the uplink scheduling grant included in the DCI Format 0 expresses a resource indicator (RIV(x₁, x₂, . . . , xₖ, n)) of a resource allocation field by detecting the DCI format 0 as described above, the uplink scheduling grant may be interpreted by calculating an RIV through decoding process and calculating coefficients of a corresponding resource indicator.

Functions, such as downlink scheduling assignments, uplink scheduling acknowledgement, power control, and the like, associated with a component carrier identified by a component carrier indicator, are performed using information associated with downlink scheduling assignments, uplink scheduling acknowledgement, and power control commands included in control information obtained by detecting other DCI formats.

A control information processing method that has been described with reference to FIG. 11 is generalized as follows.

A user equipment processes control information by demapping, into symbols (CCE to RE demapping), a physical resource element through which control information is received from a base station, generating data by demodulating demapped symbols, performing channel decoding on demodulated data, performing CRC checking for error detection, removing a CRC from decoded data and obtaining control information, and interpreting resource allocation information expressed as RIV(x₁, x₂, . . . , xₖ, n) from obtained control information.

FIG. 12 is a block diagram of a user equipment according to another embodiment of the present invention.

Referring to FIG. 1 and FIG. 12, the user equipment receives a signal from a base station through an antenna.

A demodulation unit 1220 provides a function of demodulating the received signal. When the base station transmits an OFDM signal, the demodulation unit 1220 proceeds with demodulation based on an OFDM scheme. Also, the demodulation unit 1220 may perform demodulation based on whether a signal generated by the base station corresponds to an FDD scheme or a TDD scheme.

The demodulated signal is descrambled in a descrambling unit 1230, and a codeword of a predetermined length is generated. A codeword decoding unit 1240 restores the codeword into predetermined control information. This function may be performed by the signal decoding unit 1290 at once, or the function is independently or sequentially operated in two or more modules.

Finally, the resource allocation information expressed as RIV(x₁, x₂, . . . , xₖ, n) is interpreted from the restored control information in a higher layer than a physical layer where a signal is restored.

Also, the resource allocation information expressed in the resource allocation field may be interpreted as a single numbering system that has been described with reference to FIGS. 16 through 19, Equations 10 and 11, and Table 3 through 5, or is interpreted as a contiguousness/non-contiguousness distinguishing bit that is applied by applying a single numbering system.

For example, referring to Equation 10 and FIG. 17, when a field value of a resource allocation field is interpreted to be

$$0 \sim \frac{n ( n + 1 )}{2} - 1 ,$$

it is interpreted as contiguous resource allocation without frequency hopping. When the field value is interpreted to be

$$\frac{n ( n + 1 )}{2} \sim \frac{n ( n + 1 )}{2} + {2}^{Q} - 1 ,$$

it is interpreted as contiguous resource allocation with frequency hopping. When the field value is interpreted to be

$$\frac{n ( n + 1 )}{2} + {2}^{Q} \sim \frac{n ( n + 1 )}{2} + {2}^{Q} + {}_{{n}^{′} + 1}^{}{C}{}_{4}^{} - 1 ,$$

it is interpreted as non-contiguous resource allocation.

For another example, referring to Table 4 and (A) through (C) of FIG. 18, when 2^{Q+1}<_{n′+1}C₄, a field value of the non-contiguous resource allocation field 1940 is interpreted to be non-contiguous resource allocation information, a field value of the frequency hopping field 1920 is 0 as illustrated in (A) of FIG. 18, and a field value of the resource allocation field 1910 is a range of

$$\frac{n ( n + 1 )}{2} \sim {2}^{Q} - 1$$

that is not used for contiguous resource allocation without frequency hopping, it is interpreted to be the remaining resource allocation information of the non-contiguous resource allocation.

A configuration of a part of a field of a DCI format may be used for a different purpose. That is, a part of a value of a resource allocation field or a combination of other fields associated with resource allocation proposed in the present invention may be used for another purpose. For example, both a resource allocation field and a frequency hopping field have a value of “1”, and may be utilized for activation and release of SPS (Semi-Persistent Scheduling). SPS refers to a scheme of fixedly scheduling control information through one activation, without additional transmission of a physical downlink control channel, until it is released. As described above, when the configuration is used for another application, a field numbering system or a combination field numbering system is configured excluding the corresponding field value and the corresponding combination field value. For example, when n=7, and a frequency hopping field, a resource allocation field, and a distinguishing field are in a form of “111111110” and are used for SPS, a numbering system may be configured in a way that “111111110” does not exist after “111111101” and the numbering system proceeds with “111111111”

A method and apparatus for providing uplink scheduling grant or PUSCH grant using a PDCCH DCI format 0 during non-contiguous resource allocation, and a method and apparatus for restoring resource allocation information have been described. Hereinafter, transmission of non-contiguous resource allocation information performed in a format and a size identical to the format and the size used for transmission of contiguous resource allocation information will be described.

As described above, although it is not limited thereto, control information of uplink resource allocation is transmitted through uplink grant and this corresponds to the DCI format 0. In this example, as a number of clusters of non-contiguous resource allocation have been increased, an amount of resource allocation information for expressing the clusters, that is, a range of an RIV, has also increased and thus, an amount of bits required has increased and overhead has also increased. In this example, a number of clusters of non-contiguous resource allocation may be 2 through 4. As described above, an increase in the number of clusters increases overhead but may cause improvement of throughout since a number of non-contiguous clusters is increased.

A resource allocation method of 2 non-contiguous clusters has been described with reference to FIGS. 2 and 3, a resource indicator has been expressed based on Equations 2 and 3, a resource allocation method of 3 non-contiguous clusters has been described with reference to FIGS. 6 and 7, and a resource indicator has been expressed based on Equations 4 and 5.

A non-contiguous resource allocation method that expresses k clusters by allocating j resource areas in a total of n resource block groups and combining allocation of k−1 clusters in a range of j−2 has been described with reference to FIG. 8, and it is generalized and expressed as Equation 6.

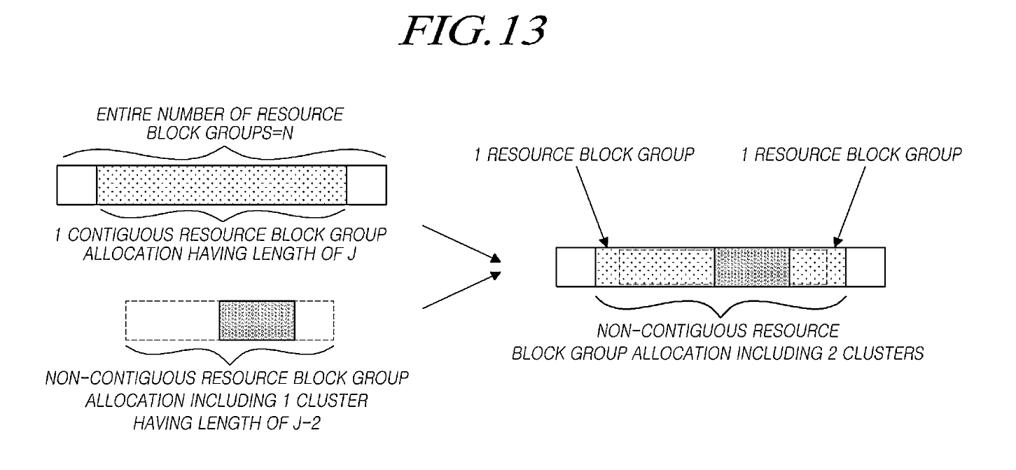

FIG. 13 is substantially identical to FIG. 8, excluding that a range of j is limited. Hereinafter, a non-contiguous resource allocation method that provides a benefit of improvement in throughput from the non-contiguous resource allocation and does not exceed a size of uplink grant will be described.

Referring to FIG. 13, j may have all of the values in a range of 2k−1˜n, and may have a range of 2k−1˜m. That is, a range of m corresponds to a range of 2k−1=m<n. Therefore, the range of j in FIG. 13 is 2k−1=j=m (2k−1=m<n). Therefore, the clusters of FIG. 13 have different sizes and may be unequal in a range determined by m. A maximum range area that a beginning of a first cluster and an ending of a last cluster may have is m, and the maximum range area may exist in any of the entire area of a range of 1˜n

In the case of the resource allocation method of 2 non-contiguous clusters that has been described with reference to FIGS. 2 and 3 (the case of 2 clusters), a value of j corresponds to x and thus, may have a range of 3=x=m(3=m<n). In the case of the resource allocation method of 3 non-contiguous clusters that has been described with reference to FIGS. 6 and 7 (the case of 3 clusters), a value of j corresponds to a and thus, may have a range of 5=a=m(5=m<n). The resource allocation method of 2 non-contiguous clusters that has been described with reference to FIGS. 2 and 3, and the resource allocation method of 3 non-contiguous clusters that has been described with reference to FIGS. 6 and 7 are identical to the above mentioned descriptions, excluding the ranges of x and a and thus, the detailed descriptions thereof will be omitted.

Transmission of non-contiguous resource allocation information performed based on a control information format identical to the control information format used for transmission of the contiguous resource allocation information has been described. However, a process of determining an m value based on an amount of predetermined bits required during non-contiguous resource allocation, and the m value will be described.

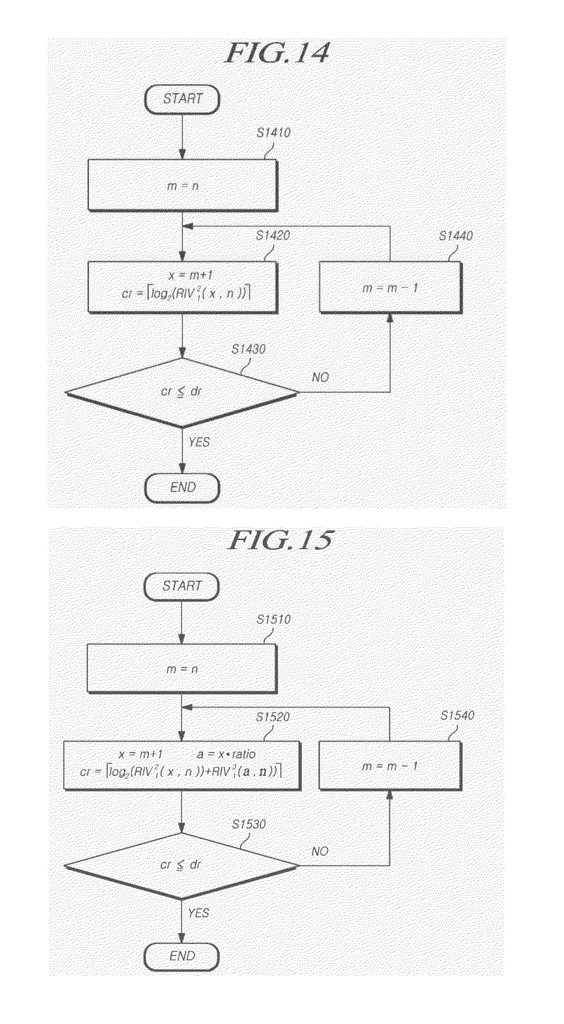

FIG. 14 illustrates a process of determining an m value based on a predetermined amount of bits required during resource allocation of 2 non-contiguous clusters.

Referring to FIG. 14, first, the m value is set to n in step S1410.

Subsequently, an amount of binary bits of all possible events of a range that all clusters have (a range indicated by a starting point of a first cluster and an ending point of a last cluster) is calculated in step S1420. In Equation 2 or Equation 3, RIV₁(x,n) indicates all possible events up to x−1 and thus, when x=m+1, RIV₁(m+1,n) indicates all events of a range that all clusters have (a range indicated by a starting point of a first cluster and an ending point of a last cluster, and the value is m). In this example, to express the case of two clusters, a superscript “2” has been added to RIV₁(x,n), as shown in RIV₁²(x,n). Accordingly, a decrease in an amount of bits required, associated with the m value, may be calculated and obtained as shown in the following equation. cr indicates an amount of bits required, which is given by each x=m+1.

$$x = m + 1 \\ cr = ⌈ {log}_{2} ( R I {V}_{1}^{2} ( x , n ) ) ⌉ \qquad [ Equation 12 ]$$

Subsequently, cr which is an amount of bits required, given by each x=m+1 and dr which is an amount of bits required, which is a target amount, are compared so that whether cr is less than or equal to dr is determined in step S1430. When cr is greater than dr, step S1420 and step S1430 are repeated with respect to an m value obtained by subtracting 1 from the m value in step S1440.

When cr is less than or equal to dr, m is a range of all clusters that may satisfy the target required bit amount.

FIG. 15 illustrates a process of determining an m value based on a predetermined amount of bits required, during resource allocation of 3 non-contiguous clusters provided in a form in which two and three clusters are combined.

Referring to FIG. 15, first, an m value is set to n in step S1510.

Subsequently, an amount of binary bits of all possible events of a range that all clusters have (a range indicated by a starting point of a first cluster and an ending point of a last cluster) is calculated in step S1520.

As described above, RIV₁²(x,n) indicates all possible events of a range that all of the two clusters have, and RIV₁³(a,n) indicates all possible event of a range that all of the three clusters have (a superscript “3” indicates three clusters). Therefore, a sum of RIV₁²(x,n) and RIV₁³(a,n) indicates all events of a range that all of the two and three clusters have. Therefore, a decrease in an amount of bits required, associated with an m value, may be calculated and obtained as shown in Equation 11. cr indicates an amount of bits required, given by each x=m+1.

$$x = m + 1 , a = x * ratio \\ cr = ⌈ {log}_{2} ( R I {V}_{1}^{2} ( x , n ) + R I {V}_{1}^{3} ( a , n ) ) ⌉ \qquad [ Equation 13 ]$$

In this example, “ratio” in a=x*ratio indicates a relative ratio of an entire range that two clusters have to an entire range that three cluster have.

Subsequently, cr which is an amount of bits required, given by each x=m+1 and dr which is an amount of bits required, which is a target amount, are compared so that whether cr is less than or equal to dr is determined in step S1530. When cr is not equal or less than dr, that is, when cr is greater than dr, steps S1520 and S1530 are repeatedly performed with respect to a value obtained by subtracting 1 from the m value.

When cr is equal or less than dr, m is a range of all clusters that may satisfy the target required bit amount.

When an m value is calculated in a case in which dr is set to be 1 bit less than an amount of bits of resource allocation that an uplink grant has, it is as shown in Table 6 for a case of ratio=1.

TABLE 6

| | | | amount of | | | |
|---|---|---|---|---|---|---|
| | | number of | bits of | | | |
| | number of | resource | resource | | | |
| | resource | block | allocation | | | |
| bandwidth | blocks | groups | field (RA | m, dr = RA | m, dr = RA | m, dr = RA + 1 |
| (MHz) | (#ofRB) | (#ofRBG) | map size) | (2 clusters) | (2 + 3 clusters) | (2 + 3 clusters) |
| 1.4 | 6 | 6 | 5 | 5 | 5 | 6 |
| 3 | 15 | 8 | 7 | 8 | 6 | 8 |
| 5 | 25 | 13 | 9 | 8 | 7 | 8 |
| 10 | 50 | 17 | 11 | 12 | 8 | 10 |
| 15 | 75 | 19 | 12 | 16 | 9 | 11 |
| 20 | 100 | 25 | 13 | 16 | 10 | 12 |

In Table 6, RA indicates an amount of bits of a resource allocation field that uplink grant DCI format 0 has. For example, when a bandwidth (BW) is 20 MHz, a number of resource blocks is 100, and a number of resource block groups is 25, an amount of bits (RA) of a resource allocation field that uplink grant DCI format 0 has is 13 bits. In this example, when cr is less than or equal to dr, m is 10. In a case in which 1 bit more than RA is available, m is 12. The case in which 1 bit more than RA is available indicates a case in which a FH (frequency hopping) bit is used as a resource allocation field for a situation of non-contiguous resource allocation.

The descriptions have been provided by exemplifying the case in which a number of non-contiguous clusters is 2 or 3 with reference to FIGS. 14 and 15. When the number of non-contiguous clusters is 4 or more, the m value may be determined in the same manner. That is, when the number of contiguous clusters is k, all events of a range that all of the k clusters have are calculated and an m value that satisfies a condition in which a binary value of the calculated value is less than or equal to an amount of bits (RA) of a resource allocation field that uplink grant DCI format 0 has or the amount of bits of the resource allocation field+1(RA+1).

Therefore, the range of j is smaller than a number of the entire resource block groups in FIG. 13 and thus, a format of a PDCCH having non-contiguous resource allocation is maintained to be the same as a size of a PDCCH that has contiguous resource allocation. Accordingly, throughput associated with non-contiguous resource allocation is improved without increasing a number of blind decodings.

Also, a maximum range area that a starting point of a first cluster and an ending point of a last cluster may have during non-contiguous resource allocation has a maximum range m and thus, may positively affect an interference problem occurring in transmission of non-contiguous clusters from a perspective of the RF standard. That is, as a distance between clusters has increased, the interference problem has become worse. As described above, the maximum range area that the beginning of the first cluster and the ending of the last cluster have during the non-contiguous resource allocation is set to be smaller than the number of the entire resource block groups and thus, the distance between the clusters becomes short and the interference problem from a perspective of the RF standard may be overcome.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A resource allocation method of a base station, the method comprising:
allocating resources contiguously or non-contiguously with respect to k (k denotes a natural number greater than or equal to 1) clusters including one or more resource block groups from among entire resource block groups of a predetermined user equipment in a wireless communication system; and
generating resource allocation information including a resource indicator (RIVₜₒₜₐₗ(k)) with respect to the allocated contiguous or non-contiguous resources, which is based on a numerical expression of
$${RIV}_{total} ( k ) = {\sum }_{i = 1}^{k - 1} R I {V}^{max} ( i ) + R I V ( k ) ,$$
wherein RIV(k) denotes a value that indicates a resource indicator with respect to contiguous or non-contiguous resource allocation having k clusters and that begins with 0, RIV(1) includes contiguous resource allocation with frequency hopping and contiguous resource allocation without frequency hopping, and RIV^{max}(i) is a maximum value of RIV(i) with respect to i clusters.

2. The resource allocation method of claim 1, wherein the resource allocation information allocates a range of a resource indicator (RIVₜₒₜₐₗ(1)) with respect to contiguous resource allocation to
$$0 \sim \frac{n ( n + 1 )}{2} - 1$$
(n denotes a number of resource blocks) in a case of no frequency hopping, allocates the range to
$$\frac{n ( n + 1 )}{2} \sim \frac{n ( n + 1 )}{2} + {2}^{Q} - 1$$
$$( Q = ⌈ {log}_{2} ( \frac{n ( n + 1 )}{2} ) ⌉$$
and ┌a┐ and is integer greater than and close to a) in a case of frequency hopping, and allocates a range of a resource indicator (RIVₜₒₜₐₗ(k) and k is greater than or equal to 2) with respect to non-contiguous resource allocation to
$$\frac{n ( n + 1 )}{2} + {2}^{Q} \sim \frac{n ( n + 1 )}{2} + {2}^{Q} + {}_{{n}^{′} + 1}^{}{C}{}_{4}^{} - 1 ( {n}^{′} = \frac{n}{P}$$
and P denotes a size of a resource block group (RBG)).

3. The resource allocation method of claim 1, further comprising:
including the resource allocation information in a resource allocation field of a predetermined Downlink Control Information (DCI) format to which at least one different field is added, and transmitting the resource allocation field to the predetermined user equipment through a Physical Downlink Control Channel (PDCCH).

4. The resource allocation method of claim 3, wherein the different field corresponds to a frequency hopping field and a contiguousness/non-contiguousness distinguishing field.

5. A resource allocation method of a base station, the method comprising:
allocating resources contiguously or non-contiguously with respect to k (k is a natural number greater than or equal to 1) clusters including one or more resource block groups from among entire resource block groups of a predetermined user equipment in a wireless communication system; and
generating control information including a contiguous or non-contiguous resource allocation field that expresses resource allocation information with respect to the allocated contiguous or non-contiguous resources,
wherein, if a contiguousness/non-contiguousness distinguishing field included in the control information expresses contiguous resource allocation, the control information expresses contiguous resource allocation information using a range used for contiguous resource allocation with respect to a field value of the contiguous resource allocation field and expresses a part of the non-contiguous resource allocation information using the remaining range that is not used for the contiguous resource allocation, and
if the contiguousness/non-contiguousness distinguishing field expresses non-contiguous resource allocation, the control information expresses another part of the non-contiguous resource allocation information using entire range with respect to a field value of the non-contiguous resource allocation field, which is obtained by adding a single bit to the contiguous resource allocation field.

6. The resource allocation method of claim 5, wherein the single bit that is further added to the non-contiguous resource allocation field is a frequency hopping field that expresses whether to perform frequency hopping, and
if the contiguousness/non-contiguousness distinguishing field included in the control information expresses contiguous resource allocation and the frequency hopping field expresses no-frequency hopping, the control information expresses contiguous resource allocation information using a range used for the contiguous resource allocation with respect to a field value of the contiguous resource allocation field and expresses a part of the non-contiguous resource allocation using the remaining range that is not used for the contiguous resource allocation.

7. The resource allocation method of claim 6, wherein, if the frequency hopping field expresses no-frequency hopping, the range used for contiguous resource allocation is
$$0 \sim \frac{n ( n + 1 )}{2} - 1$$
(n denotes a number of resource blocks) and the remaining range that is not used for the contiguous resource allocation is
$$\frac{n ( n + 1 )}{2} \sim {2}^{Q} - 1 ( Q = ⌈ {log}_{2} ( \frac{n ( n + 1 )}{2} ) ⌉$$
and ┌a┐ and denotes an integer greater than and close to a).

8. A resource allocation information processing method of a user equipment, the method comprising:
receiving, from a base station, control information including contiguous or non-contiguous resource allocation information that is information for allocating resources contiguously or non-contiguously with respect to k (k is a natural number greater than or equal to 1) clusters including one or more resource block groups from among entire resource block groups of a predetermined user equipment and that includes a resource indicator (RIVₜₒₜₐₗ(k)) with respect to the allocated contiguous or non-contiguous resources, which is based on
$$R I {V}_{total} ( k ) = {\sum }_{i = 1}^{k - 1} R I {V}^{max} ( i ) + R I V ( k ) ;$$
and
interpreting the contiguous or non-contiguous resource allocation information from the received control information,
wherein RIV(k) denotes a value that indicates a resource indicator with respect to contiguous or non-contiguous resource allocation having k clusters and that begins with 0, RIV(1) includes contiguous resource allocation with frequency hopping and contiguous resource allocation without frequency hopping, and RIV^{max}(i) is a maximum value of RIV(i) with respect to i clusters.

9. The resource allocation information processing method of claim 8, wherein the resource allocation information allocates a range of a resource indicator (RIVₜₒₜₐₗ(1)) with respect to contiguous resource allocation to
$$0 \sim \frac{n ( n + 1 )}{2} - 1$$
(n is a number of resource blocks) in a case of no-frequency hopping, allocates the range to
$$\frac{n ( n + 1 )}{2} \sim \frac{n ( n + 1 )}{2} + {2}^{Q} - 1 ( Q = ⌈ {log}_{2} ( \frac{n ( n + 1 )}{2} ) ⌉$$
and ┌a┐ is integer greater than and close to a) in a case of frequency hopping, and allocates a range of a resource indicator (RIVₜₒₜₐₗ(k) and k is greater than equal to 2) with respect to non-contiguous resource allocation to
$$\frac{n ( n + 1 )}{2} + {2}^{Q} \sim \frac{n ( n + 1 )}{2} + {2}^{Q} + {}_{{n}^{′} + 1}^{}{C}{}_{4}^{} - 1 ( {n}^{′} = \frac{n}{P}$$
and P denotes a size of a resource block group (RBG)).

10. A resource allocation information processing method of a user equipment, the method comprising:
receiving control information that includes a contiguous or non-contiguous resource allocation field that contiguously or non-contiguously allocates resources with respect to k (k is a natural number greater than or equal to 1) clusters including one or more resource block groups from among entire resource block groups of a predetermined user equipment and expresses resource allocation information associated with the allocated contiguous or non-contiguous resources; and
interpreting the contiguous or non-contiguous resource allocation information from the received control information,
wherein, if a contiguousness/non-contiguousness distinguishing field included in the control information expresses contiguous resource allocation, the control information expresses contiguous resource allocation information using a range used for contiguous resource allocation with respect to a field value of the contiguous resource allocation field and expresses a part of the non-contiguous resource allocation information using the remaining range that is not used for the contiguous resource allocation, and
if the contiguousness/non-contiguousness distinguishing field included in the control information expresses non-contiguous resource allocation, the control information expresses another part of the non-contiguous resource allocation information using the entire range with respect to a field value of the non-contiguous resource allocation field, which is obtained by adding a single bit to the contiguous resource allocation field.

11. The resource allocation information processing method of claim 10, wherein a bit that is further added to the non-contiguous resource allocation field is a frequency hopping field that expresses whether to perform frequency hopping, and
if the contiguousness/non-contiguousness distinguishing field included in the control information expresses contiguous resource allocation and the frequency hopping field expresses no-frequency hopping, the control information expresses contiguous resource allocation information using a range used for the contiguous resource allocation with respect to a field value of the contiguous resource allocation field and expresses a part of the non-contiguous resource allocation using the remaining range that is not used for the contiguous resource allocation.

12. The resource allocation information processing method of claim 11,
wherein, if the frequency hopping field expresses no-frequency hopping, the range used for contiguous resource allocation is
$$0 \sim \frac{n ( n + 1 )}{2} - 1$$
(n denotes a number of resource blocks) and the remaining range that is not used for contiguous resource allocation is
$$\frac{n ( n + 1 )}{2} \sim {2}^{Q} - 1 ( Q = ⌈ {log}_{2} ( \frac{n ( n + 1 )}{2} ) ⌉$$
and ┌a┐ denotes an integer greater than and close to a).
